(19) United States
(12) Patent Application Publication
(10) Pub. No.: US 2005/0125570 A1
(43) Pub. Date: Jun. 9, 2005

(54) Portable communication devices

(76) Inventors: Robert Olodort, Santa Monica, CA (US); Peter M. Cazalet, Campbell, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,226

(22) Filed: Sep. 30, 2004

Related U.S. Application Data
(63) Continuation-in-part of application No. 10/763,874, filed on Jan. 23, 2004.
(60) Provisional application No. 60/514,194, filed on Oct. 23, 2003.

(51) Int. Cl. G06F 3/00; H04Q 7/20

(52) U.S. Cl. 710/15

(57) ABSTRACT

A portable communication device which, in one exemplary embodiment, includes a first position to cover a display assembly and a keyboard assembly, a second position to form a mobile voice phone and a third position to form a personal digital assistant. In this exemplary embodiment, a display on the display assembly is in a portrait mode relative to said keyboard assembly in the second position and the display on the display assembly is in a landscape mode relative to said keyboard assembly in the third position. Other embodiments are disclosed.

This application is a Continuation-In-Part of U.S. patent application Ser. No. 10/763,874 entitled “PORTABLE COMMUNICATION DEVICES,” filed Jan. 23, 2004, the contents of which are incorporated by reference herein, which is also related to and claims the benefit of the filing date of a provisional U.S. Patent Application Ser. No. 60/514,194, which was filed Oct. 23, 2003 by inventors Robert Olodort and Peter M. Cazalet under Attorney Docket No. 003256.P020Z.

### FIELD OF THE INVENTION

This invention relates to the field of portable communication devices and, in particular, to a compact digital processing device having mobile voice phone and PDA features.

### BACKGROUND

Personal Digital Assistants (PDAs) have succeeded as electronic solutions for the replacement of conventional pen and paper type calendars and address books. Unlike notebook computers, PDAs are small enough to hold in the palm of one hand (e.g., grasped entirely within the fingers of one hand) or fit in a pocket. In today's wireless age, mobile or cellular phones, text-messaging devices, and pagers allow people to communicate from virtually any location. Many PDAs also have wireless capabilities, allowing users to surf the web and access email. The need for the features and flexibilities that these wireless devices provide often require users to carry around mobile (e.g. cellular) phones, text-messaging devices, and PDAs separately.

Attempts have been made to consolidate these features into a single, portable device, commonly referred to as a smartphone—a generic name for a voice-centric mobile voice phone with information capabilities. However, current smartphones possess practical and aesthetic problems that fail to strike a good balance between a mobile voice phone and a PDA. FIGS. 1A and 1B illustrate an example of a prior art smart phone. FIG. 1A shows a smart phone in a phone configuration having a “candy-bar” style with a display and keypad. FIG. 1B shows the smart phone in a PDA or portable computer configuration that is formed by flipping open a section of the phone to reveal a second, larger display and a miniature keyboard. The device is large and bulky, making it inconvenient for a user to carry in a pant pocket or on a belt holster. Holding such a bulky, substantially planar device to the ear during phone use is not aesthetically pleasing. Users may prefer the feeling of a conventional phone, that is, a receiver having a curved, narrow body that is contoured to fit the shape of a user's head from the ear to the mouth. Moreover, the candy bar style of many mobile voice phones do not have distinctive ear and mouth pieces, making it difficult for users to feel what the proper position of the phone should be during use. This may cause the user to constantly adjust the phone around the ear and mouth and vary the pressure to which the phone is held against the user's head. Another disadvantage of prior art smartphones is that the display and keypad of the phone are always exposed, making them susceptible to damage when carried around.

FIGS. 1C and 1D illustrate another prior art smartphone that has a base section that rotates from the phone configuration of FIG. 1C to expose a thumb-style keyboard in the PDA configuration of FIG. 1D. This prior art phone is further shown in published U.S. Patent Application Publication Number U.S. 2003/0087609. The mobile voice phone configuration has a candy-bar style that remains bulky and exposes the display and keypad to damage. In the PDA configuration, the key layout is not centered with respect the display screen, making it awkward for a user to quickly and accurately enter data because the user's hands would be in an unbalanced position. Moreover, the display size is a small fraction of the overall area of the phone, thereby limiting the amount of text or image that may be viewed.

### SUMMARY

In one embodiment of the present invention, a portable communication device includes a first position (e.g. a first configuration) to cover a display assembly and a keyboard assembly, a second position (e.g. a second configuration) to form a mobile voice phone and a third position (e.g. a third configuration) to form a personal digital assistant or to otherwise provide a mode or configuration in which a full keyboard is available for use. A display on the display assembly is (in this exemplary embodiment) in a portrait mode relative to said keyboard assembly in the second position and the display on the display assembly is in a landscape mode relative to said keyboard assembly in the third position.

In another exemplary embodiment, a portable communication device includes a keyboard assembly having a keyboard with alphanumeric keys and a display assembly having a display, where the display assembly is coupled to the keyboard assembly and is moveable relative to the keyboard assembly between a first open position and a second open position, the first open position being for a voice phone mode and the second open position being for a full alphanumeric keyboard mode. The keyboard assembly and the display assembly are moveable relative to each other to a closed position in which the display and alphanumeric keys are protected and are not on an exterior surface in the closed position.

In another exemplary embodiment, a portable communication device includes a keyboard assembly having a keyboard with a plurality of alphanumeric keys arranged substantially in rows and columns, wherein the rows and columns are specified by a first up/down direction of a first set of indicia (e.g. the letters on the keys of a QWERTY keyboard) associated with at least a subset of the plurality of alphanumeric keys and wherein there are more columns than rows and wherein the up/down direction of the first set of indicia is aligned substantially parallel with the columns and wherein a second up/down direction of a second set of indicia (e.g. the numbers 0-9 for a voice phone keypad), associated with at least another subset of the plurality of alphanumeric keys, is aligned substantially perpendicular to the first up/down direction; and the portable communication device includes a display assembly which has a display and which is moveably coupled to the keyboard assembly from an open position which exposes the keyboard and the display to a closed position in which the display and the keyboard are protected and are not on an exterior surface in the closed position.

In another exemplary embodiment, a portable communication device includes a keyboard assembly having a keyboard with a plurality of alphanumeric keys arranged substantially in rows and columns, wherein the rows and columns are specified by a first up/down direction of a first set of indicia (e.g. the letters on the keys of a QWERTY keyboard) associated with at least a subset of the plurality of alphanumeric keys and wherein there are more columns than rows and wherein the up/down direction of the first set of indicia is aligned substantially parallel with the columns and wherein a second up/down direction of a second set of indicia (e.g. the numbers 0-9 for a voice phone keypad), associated with at least another subset of the plurality of alphanumeric keys, is aligned substantially perpendicular to the first up/down direction; and the portable communication device includes a display assembly coupled to the keyboard assembly, wherein the keyboard assembly has a first long side and a first short side and the display assembly has a second long side and a second short side and wherein in a voice phone mode, the first short side and the second short side are substantially abutting, and wherein in a full keyboard mode the first long side and the second long side are substantially abutting.

In another exemplary embodiment, a portable communication device includes a keyboard assembly having a keyboard with a plurality of alphanumeric keys arranged substantially in rows and columns, wherein the rows and columns are specified by a first up/down direction of a first set of indicia (e.g. the letters on the keys of a QWERTY keyboard) associated with at least a subset of the plurality of alphanumeric keys and wherein there are more columns than rows and wherein the up/down direction of the first set of indicia is aligned substantially parallel with the columns and wherein a second up/down direction of a second set of indicia (e.g. the numbers 0-9 for a voice phone keypad), associated with at least another subset of the plurality of alphanumeric keys, is aligned substantially perpendicular to the first up/down direction; and the portable communication device includes a display assembly which has a display and which is coupled to the keyboard assembly, the display having a first orientation in a voice phone mode in which text on the display is substantially parallel to the columns and a second orientation in which text on the display is substantially perpendicular to the columns, and wherein in the voice phone mode the display assembly and the keyboard assembly form an angle in a range of about 100° to about 170°.

In another exemplary embodiment, a portable communication device includes a keyboard assembly having a full alphanumeric set of keys and having a first long side and a first short side, and a display assembly having a display and being coupled to the keyboard assembly, the display assembly having a second long side and a second short side, and wherein the display has a first orientation in a voice phone mode in which text on the display is substantially parallel to the first short side and a second orientation in a full keyboard mode in which text on the display is substantially perpendicular to the first short side, and wherein in the voice phone mode, the first short side and the second short side are substantially abutting and/or parallel and wherein in the full keyboard mode the first long side and the second long side are substantially abutting and/or parallel.

In another exemplary embodiment, a portable communication device includes a keyboard assembly having a keyboard with a plurality of alphanumeric keys arranged substantially in rows and columns, wherein the rows and columns are specified by a first up/down direction of a first set of indicia (e.g. the letters on the keys of a QWERTY keyboard) associated with at least a subset of the plurality of alphanumeric keys, and wherein there are more columns than rows, and wherein the first up/down direction is aligned substantially parallel with the columns; and the device includes a display assembly which has a display and which is moveably coupled to the keyboard assembly to permit movement from an open position which exposes the keyboard and the display to a closed position in which the display and the keyboard are protected and are not on an exterior surface in the closed position; a microphone on the keyboard assembly, the microphone positioned near a lower, central portion of the keyboard assembly; and an earpiece on the display assembly, the earpiece positioned near an upper, central portion of the display assembly.

In another exemplary embodiment, a portable communication device includes a keyboard assembly having a keyboard with a plurality of alphanumeric keys arranged substantially in rows and columns, wherein the rows and columns are specified by a first up/down direction of a first set of indicia (e.g. the letters on the keys of a QWERTY keyboard) associated with at least a subset of the plurality of alphanumeric keys, and wherein there are more columns than rows and wherein the up/down direction is aligned substantially parallel with the columns; and the device includes a display assembly which has a display and which is coupled to the keyboard assembly, the display having a first orientation in a voice phone mode in which a line or a row of text on the display is substantially parallel to the columns and a second orientation in which another line or row of text on the display is substantially perpendicular to the columns, and wherein the keyboard has a unitary structure which is fully accessible when the display is in either of the first and the second orientations.

In another exemplary embodiment, a portable communication device includes a keyboard assembly having a keyboard with a plurality of alphanumeric keys. A first up/down direction of a first set of indicia is associated with at least a subset of the plurality of alphanumeric keys, and a second up/down direction of a second set of indicia, which is associated with at least some of the plurality of alphanumeric keys, is aligned substantially perpendicular to the first up/down direction. A display assembly has a display and is coupled to the keyboard assembly. The display has a first orientation in a voice phone mode in which a row of text on the display is substantially parallel to the first up/down direction and a second orientation (e.g. in a full keyboard mode) in which another row of text on the display is substantially perpendicular to the first up/down direction. In the voice phone mode, the display assembly and the keyboard assembly form an angle in a range of about 100° to about 170°.

In another exemplary embodiment, a portable communication device includes a display assembly which has a display and a keyboard assembly which has a plurality of alphanumeric keys. The keyboard assembly is rotatably coupled to a base assembly which is coupled to the display assembly. The keyboard assembly has a first long side and a first short side. A first up/down direction of a first set of indicia is associated with at least a subset of the plurality of alphanumeric keys and a second up/down direction of a second set of indicia is associated with at least some of the plurality of alphanumeric keys. The first up/down direction is substantially perpendicular to the second up/down direction. The portable communication device has a closed configuration in which the display and the keyboard assembly are protected and are not on an exterior surface in the closed configuration.

In another exemplary embodiment, a portable communication device includes a keyboard assembly and a display assembly which has a display and which is coupled to the keyboard assembly. The display has a first side that defines an edge of the display. The keyboard assembly has a plurality of alphanumeric keys. A first up/down direction of a first set of indicia is associated with at least a subset of the plurality of alphanumeric keys, and a second up/down direction of a second set of indicia is associated with at least some of the plurality of alphanumeric keys. The first up/down direction is substantially perpendicular to the second up/down direction. A row of text on the display, in a first mode of the device, is in a first orientation which is parallel to the first side, and another row of text on the display, in a second mode of the device, is in a second orientation which is perpendicular to the first side.

While many of the embodiments described herein use a keyboard to accept inputs from a user, it will be appreciated that the various embodiments may use additional input devices such as a touch sensitive screen or a scroll wheel. A touch sensitive screen may be controlled by a penlike stylus or by a user's finger; such a screen may be used to display a keypad which a user can touch with a finger or a stylus. A scroll wheel may be used to move a cursor around on the display; the scroll wheel may be rolled up or down to move a cursor up or down (or left and right) on the display. The scroll wheel may also be pressable to indicate a selection of an object on the display; in this case, the scroll wheel can be used to move the cursor on the display to position the cursor relative to an object (e.g. an icon or text button) on the display and then the wheel can be pressed to indicate a selection of the object.

Additional features and advantages of these embodiments and various other embodiments of the present invention and methods of using such devices will be apparent from the accompanying drawings, and from the detailed description that follows below.

### BRIEF DESCRIPTION OF THE DRAWINGS

The present invention is illustrated by way of example and not intended to be limited by the figures of the accompanying drawings.

FIG. 1A illustrates a prior art smartphone in a phone configuration.

FIG. 1B illustrates the prior art smartphone of FIG. 1A in a PDA configuration.

FIG. 1C illustrates another prior art smartphone in a phone configuration.

FIG. 1D illustrates the prior art smartphone of FIG. 1C in a PDA configuration.

FIG. 2A illustrates one embodiment of a portable communication device in a mobile voice phone position.

FIG. 2B illustrates the portable communication device of FIG. 2A in a PDA (or full keyboard) position.

FIG. 2C illustrates the portable communication device of FIG. 2A in a closed position.

FIG. 2D illustrates the portable communication device of FIG. 2A in a partially open position.

FIG. 2E illustrates the portable communication device of FIG. 2A as the display is rotating between a voice phone position and a PDA position.

FIG. 2F shows a side view of the portable communication device of FIG. 2A in a voice phone position.

FIG. 3A illustrates an alternative embodiment of a portable communication device in a mobile voice phone position.

FIG. 3B illustrates the portable communication device of FIG. 3A in a PDA (or full keyboard) position.

FIG. 3C illustrates the portable communication device of FIG. 3A in a closed position.

FIG. 3D illustrates the portable communication device of FIG. 3A in a partially open position.

FIG. 3E illustrates the portable communication device of FIG. 3A in another partially open position.

FIG. 4A illustrates an alternative embodiment of a portable communication device in a mobile voice phone position.

FIG. 4B illustrates the portable communication device of FIG. 4A in a PDA (or full keyboard) position.

FIG. 5 illustrates an enlarged view of a particular exemplary keyboard assembly.

FIG. 6 shows an enlarged view of another exemplary keyboard assembly, showing rows and columns of keys and the relationship of text on a display assembly, in two different modes, relative to these rows and columns.

FIG. 7 is a flowchart which shows an exemplary method of using an example of a portable communication device, such as the device in FIG. 2A or the device in FIG. 3A.

FIGS. 8A-8C show an alternative embodiment of a portable communication device.

FIG. 9 shows a top view of an alternative embodiment of a portable communication device with an alternative keyboard layout in a full keyboard mode.

FIG. 10 shows a top of the portable communication device of FIG. 9 in a voice phone mode.

FIGS. 11A, 11B, and 11C show side views of another alternative portable communication device.

FIGS. 12A, 12B, 12C and 12D show views of another alternative embodiment of a portable communication device which includes a hinge mechanism which allows the display assembly to be configured relative to the keyboard assembly in both a voice phone mode and a full keyboard mode.

FIG. 13 shows an exploded view of an alternative embodiment of a portable communication device.

FIG. 14 shows an exploded view of an alternative embodiment of a portable communication device.

FIGS. 15A, 15B, and 15C show views of another alternative embodiment of a portable communication device.

FIGS. 16A, 16B and 16C show another implementation of a portable communication device.

FIGS. 17 and 18 show two other implementations of portable communication devices.

FIGS. 19A, 19B and 19C show top views of another embodiment of a portable communication device in which a keyboard assembly rotates on a base assembly which is coupled to a display assembly.

FIGS. 20A, 20B and 20C show top views of another embodiment of a portable communication device which includes an extendible keyboard assembly.

FIGS. 21A, 21B and 21C show top views of another embodiment of a portable communication device.

FIGS. 22A, 22B, 22C and 22D show top views of another embodiment of a portable communication device.

FIG. 23 shows an exemplary hardware implementation of an embodiment of a portable communication device.

FIGS. 24A-24D illustrate another embodiment of a portable communication device that may alternate between a first communication configuration and a second communication configuration.

FIG. 25 illustrates a partial see-through view of a hinge assembly in the transitional configuration, as illustrated for the portable communication device in FIG. 24C.

FIG. 26 illustrates an exploded view of a hinge assembly that also includes the components of first cam assembly.

FIG. 27 illustrates a partially see-through view of the first cam assembly disposed within the hinge assembly.

FIG. 28 illustrates another view of the hinge assembly that isolates the first cam assembly and the second cam assembly.

FIG. 29 illustrates another embodiment of a portable communication device having an alternative hinge assembly.

FIG. 30 illustrates an exploded view of the internal components of the hinge assembly illustrated in FIG. 29.

FIG. 31 illustrates a partial see-through view of the hinge assembly illustrated in FIG. 29.

### DETAILED DESCRIPTION

In the following description, numerous specific details are set forth such as examples of specific, components, circuits, processes, etc. in order to provide a thorough understanding of the present invention. It will be apparent, however, to one skilled in the art that these specific details need not be employed to practice the present invention. In other instances, well known components or methods have not been described in detail in order to avoid unnecessarily obscuring the present invention. The term “coupled” as used herein means connected directly to or indirectly connected through one or more intervening components or circuits.

Embodiments of the present invention, which include a portable communication device, are described. In one embodiment, a portable communication device includes a display assembly and a keyboard assembly that form various operating and non-operating positions. The display assembly and the keyboard assembly may be coupled together with a hinge assembly that allows the portable communication device to alternate between closed and open positions. In a closed position, the display assembly and the keyboard assembly are covered and protected in a housing. The closed position includes a small form factor to protect the display and keyboard assemblies, as well as providing convenient portability. In this closed position, the display assembly and the keyboard assembly are not exposed as external surfaces. In a first opened position, the display assembly rotates open to form a mobile voice phone position. The mobile voice phone position has the shape and feel of a conventional phone (such as a flip-open, flip-closed cell phone) to provide a user with the familiarity, ergonomics and aesthetics of a handset receiver of a land line phone. In a second opened position, the display assembly rotates open to form a full keyboard or PDA position. The display on the display assembly may also have orientation capabilities. In one embodiment of the present invention, a display on the display assembly may be in a portrait mode in the mobile voice phone position and in a landscape mode in the full keyboard or PDA position. In alternative embodiments of the present invention, a portable communication device has various positions that possess features of a smartphone.

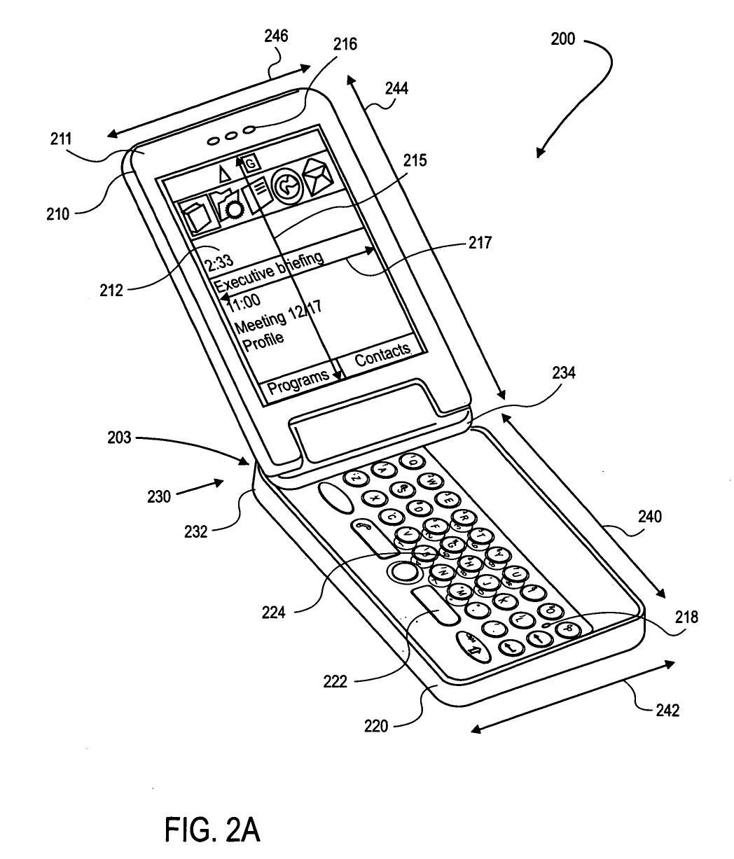

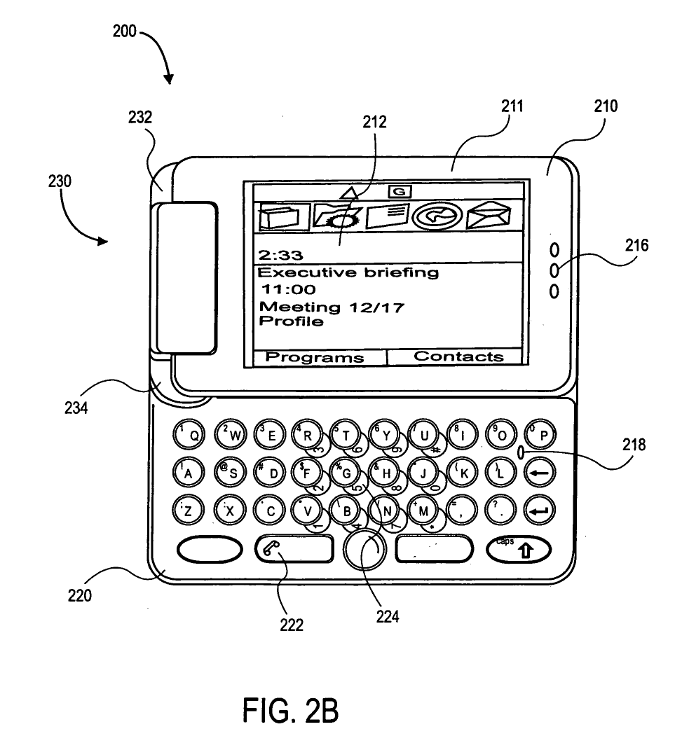

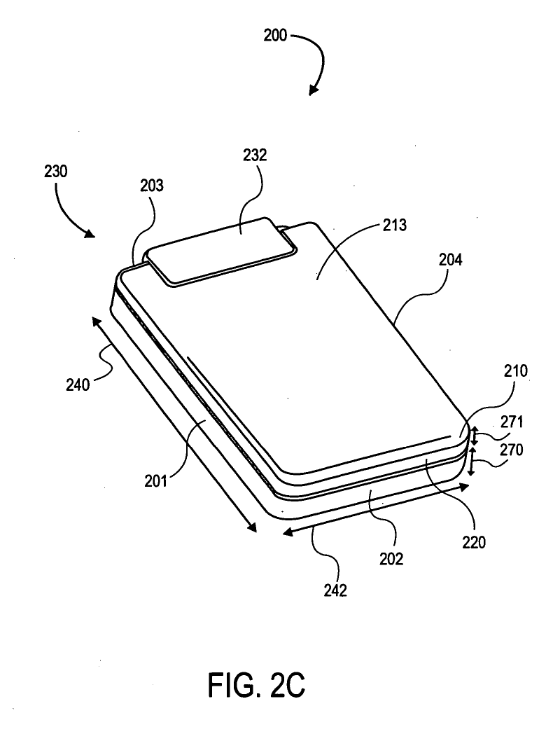

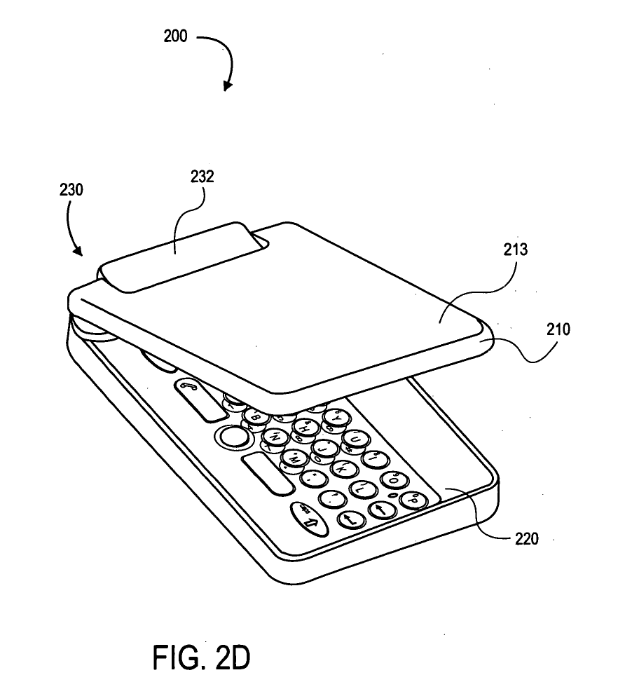

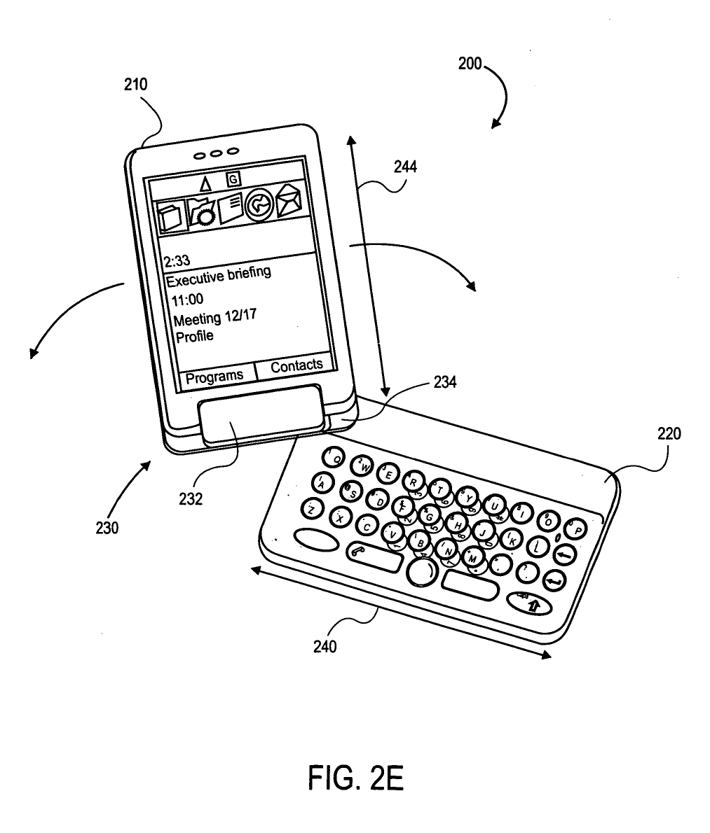

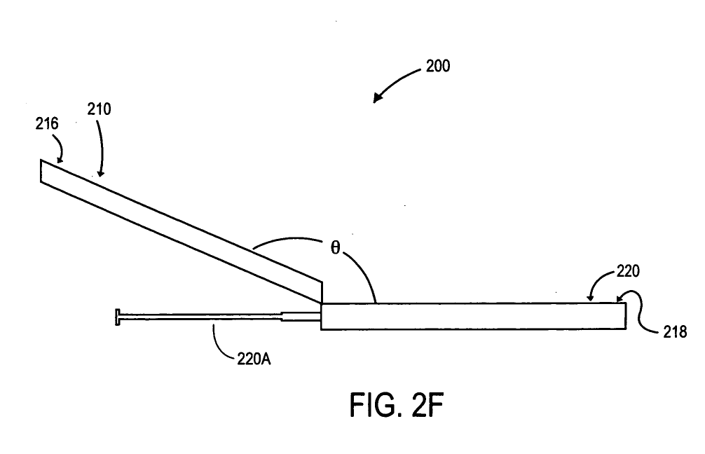

FIGS. 2A-2F illustrate various configurations or positions of one embodiment of the present invention. A portable communication device 200 alternates between at least two open positions that include a mobile voice phone position and a full keyboard or PDA position. FIG. 2A illustrates device 200 in a mobile voice phone position with display assembly 210 rotated open relative to keyboard assembly 220. Hinge assembly 230 is disposed near a left edge 203 of keyboard assembly 220 and has an elongated first hinge 232 and a second rotating hinge 234 disposed near one end of first hinge 232. As discussed in greater detail below, first hinge 232 and second rotating hinge 234 allow display assembly 210 to rotate open relative to keyboard assembly 220 into different open orientations, one to form a mobile voice phone position and a second to form a full keyboard or PDA position. In one embodiment of the present invention, display assembly 210 rotates open with first hinge 232 to form the mobile voice phone position, and rotates open with second hinge 234 to form the full keyboard or PDA position. Display assembly 210 is substantially rectangular in shape having a display assembly length 244 and width 246 where the length exceeds the width and thus the length is a long side and the width is the short side. Display screen 212 takes up a large surface area of display assembly 210 with display screen length 215 and width 217. In this case, the display screen length 215 exceeds the display screen width 217.

In the mobile voice phone position illustrated in FIG. 2A, display assembly 210 is rotated about first hinge 232. This mobile voice phone position is comparable to a flip style or clamshell style mobile (e.g. cellular) phone, with earpiece 216 disposed on display assembly 210 and microphone 218 disposed on keyboard assembly 220. The earpiece 216 is positioned near an upper, central portion of display assembly 210 as shown in FIG. 2A, and the microphone 218 is positioned near a lower, central portion of the keyboard assembly 220. Display assembly 210 also includes a frame 211 that borders display screen 212. The positions of earpiece 216 and microphone 218 simulate the relative positions on a conventional telephone handset. In one embodiment of the present invention, the mobile voice phone position formed by portable communication device 200 has the look and feel of a conventional phone—that is, the mobile voice phone mode or position simulates a mobile phone handset. Keyboard assembly length 240 and display assembly length 244 have a combined length to position earpiece 216 (which may be a miniature speaker) near a user's ear and mouthpiece 218 comfortably near a user's mouth. Keyboard assembly width 242 and display assembly width 246 are narrow (smaller than) relative to lengths 240, 244 to provide a slim body that may be held comfortably with the user's fingers or palm. Display assembly 210 also rotates open to an angle between about 100 to about 175 degrees relative to keyboard assembly 220. One angle which may be used is an angle of about 155 degrees. This angled orientation is better suited for the contoured shape of a user's head from ear to mouth, thereby providing comfort, aesthetics and better communications (due to the ear piece and mouthpiece being close to the user's ear and mouth, respectively).

FIG. 2F shows a side view of the portable communication device of FIG. 2A in the voice phone position/mode/configuration in which the device is opened (usually at a fixed angle θ) for use as a voice phone. The display assembly 210 and the keyboard assembly 220, in the opened position of FIG. 2F, form an angle θ which may be a fixed angle in the range of about 100 to about 175 degrees. In one particular embodiment, the angle θ may be about 155 degrees. In the closed position of FIG. 2C the angle between the display assembly and the keyboard assembly is about 0 degrees. An antenna 220A is shown in an extended position; the antenna may be extended from a retracted position from within the keyboard assembly 220. It can be seen from this side view that the earpiece 216 and the microphone 218 may be positioned close to the ear and mouth respectively while the antenna 220A is held farther away from the user's head than the typical position of an antenna on a “candy bar” style phone. Furthermore, the keyboard assembly 220 and the display assembly 210 shield, to at least some extent, the user from the emissions of the antenna 220A (unlike the antenna on a typical “candy bar” style phone). In an alternative configuration of the device of FIG. 2F, the antenna may be housed at least partially within the body of the keyboard assembly 220 and it may not be extendable from that body. The exterior surface of either (or both of) the keyboard assembly or the display assembly may include a display which is viewable when the phone is in a closed position; this display may show the status of the battery (e.g. remaining capacity) and the time and date and the status (e.g. received signal strength) of the radio signals between the phone and a cell tower.

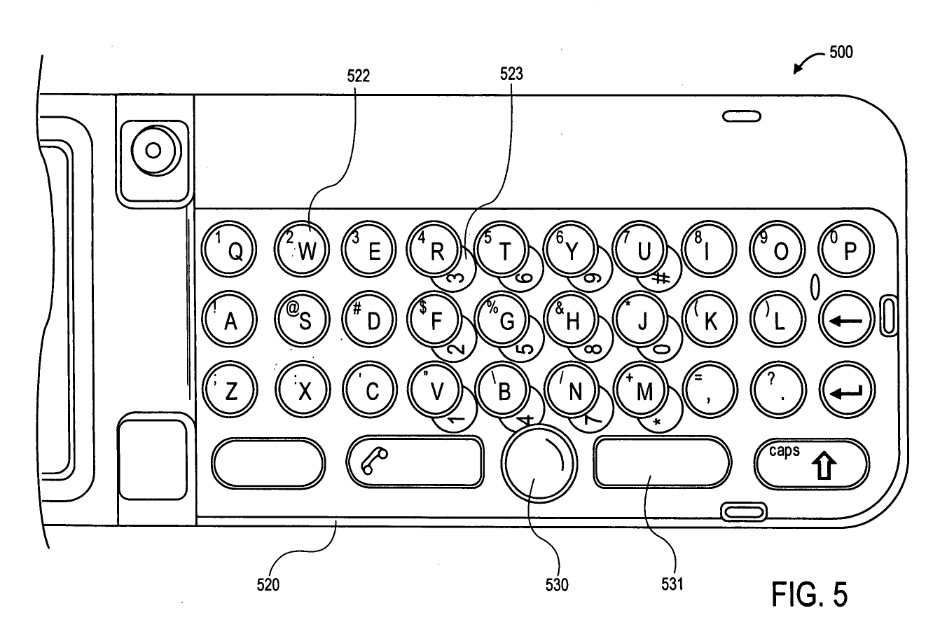

In the mobile voice phone position, an image displayed on display screen 212 (in one exemplary embodiment in which the display is a non-square, rectangular shape) is oriented in a portrait mode (text or image is viewed across the shorter display width 217 relative to the display length 215 such that the text is arranged in a linear fashion in rows which are parallel to the shorter display width 217; this can be seen in FIG. 2A). A key layout 222 is disposed on a top surface of keyboard assembly 220, with a phone keypad 224 also integrated with the keys of key layout 222. In other words, in one embodiment of the present invention, certain keys of key layout 222 double as phone keypad 224 when in the mobile voice phone position. The keys associated with the voice phone's keypad have a dual function as indicated by the two different sets of indicia which are associated with each key of the voice phone's keypad. One function of each such key in the keypad is to provide a letter or symbol from a full alphanumeric keyboard such as a QWERTY keyboard in a full keyboard mode and another function is to provide a “0-9” number (or “*” or “#” symbol or other symbols) from a voice phone's keypad. Each key in the keypad has at least one indicia from a first set of indicia (e.g. a letter and possibly a punctuation symbol from a QWERTY keyboard) and has at least one indicia from a second set of indicia (e.g. a number from 0-9 or a “*” or “#” for use as a voice phone's keypad). As can be seen from FIGS. 2A, 2B, 2E and 5, the indicia in the first set of indicia are oriented substantially perpendicularly to the indicia in the second set of indicia. For example, the number “5” on the voice phone's keypad is associated with a key for the letter G (or the symbol “%” if an alternate “Alt” key is actuated/pressed while the G key is pressed) which is part of a full alphanumeric keyboard. The number “5” is substantially perpendicular to the letter G. Thus one activatable (e.g. it can be pressed to cause an input) key has 2 different indicia which are perpendicularly oriented relative to each other. For example, when the device is opened to phone mode, pressing the key associated with G and 5 would normally input a “5”, while in full keyboard mode, the same key would normally input a “G” when pressed.

Although phone keypad keys 224 would be used primarily in the mobile voice phone position, the other keys of keyboard array 222 may also be functional in the mobile voice phone position. For example, when in phone mode, a user may look up a person's phone number by first pressing a button on the side of the phone and then pressing the alphabetical keys associated with the person's name. In an embodiment of the present invention, the keys that form phone keypad 224 may be illuminated when in the mobile voice phone position or mode to distinguish from the non-phone keypad keys which do not illuminate in this mode. In another embodiment, the keys 224 may have a color or texture which is different than the color or texture of other keys in the array 222. In yet another embodiment, the keys 224 may, in addition to being illuminated at least partially during the voice phone mode (while the rest of the keys in the array 222 are not illuminated in the voice phone mode), also have a color or texture which is different than the color or texture of the other keys in the array 222.

FIG. 5 illustrates an enlarged view of keyboard assembly 520 for portable communication device 500. In one embodiment of the present invention, keyboard assembly 520 may be used in one or more of the various portable communication devices described herein such as the one shown in FIGS. 2A-2F. Keyboard assembly 520 includes a phone key pad 523 integrated with QWERTY key layout 522 which is an example of a full keyboard. In the examples of FIGS. 2A and 5, the voice phone's keypad, which is normally used in the voice phone mode or position, includes the keys V, F, R, B, G, T, N, H, Y, M, J and U from the alphanumeric keyboard. As shown in FIG. 5, the number 1 associated with the voice phone's keypad is also associated with the key for the letter V in the alphanumeric keyboard. In the mobile voice phone position (mode), key pad 523 may be active while the remaining keys of key layout 522 remain inactive, unless an activation button (not shown) is pressed. Key layout 522 may also include a cursor controller 530 and space bar 531 and other keys or buttons which provide voice phone functions. The cursor controller 530 may be used like a mouse or trackpad to move a cursor on a display.

FIG. 2B illustrates portable communication device 200 in a full keyboard or PDA position. This mode may be used to enter text for an email or an instant message or a memo or a calendar entry or a contact or address book entry. An image on display screen 212 is oriented in a landscape mode (text or image is viewed across the longer display length 215 relative to display width 217 such that the text is arranged in a linear fashion in rows which are parallel to the longer display length 215; this can be seen in FIG. 2B). From the portrait mode image illustrated in FIG. 2A, an image on display screen 212 is rotated approximately 90 degrees and reformatted to fit within the landscape screen dimensions. Display assembly 210 rests in a plane that is substantially parallel to keyboard assembly 220 in the full keyboard or PDA position. Moreover, a portion of display assembly 210 may overlap or abut the keyboard assembly to form a single unit. First hinge 232 may be locked in the full keyboard or PDA position to prevent display assembly 210 from rotating out. It can be seen from the two views of FIGS. 2A and 2B that the keyboard assembly 220 and the display assembly 210 have rectangular shapes where a length of each rectangle is longer than a width of each rectangle. Thus, the keyboard assembly 220 has a length 240 (a long side) which is longer than a width 242 (a short side), and the display assembly 210 has a length 244 (another long side) which is longer than a width 246 (another short side). It can also be seen that, in the voice phone mode (e.g. FIG. 2A), the short sides of the two assemblies abut each other and are also parallel to each other and the device is long and narrow (so that it can be comfortably fit within a hand for use as a phone), and in the full keyboard mode (e.g. FIG. 2B), the device is shaped more like a square, nearly planar object, and the long sides of the two assemblies are parallel to each other and also abut each other. In this latter mode, the device can be comfortably held by both hands, allowing for thumb typing with one or both thumbs. The device, at least in full keyboard mode, is well balanced for typing (e.g. thumb typing) given its size and shape. Full keyboard mode may be considered to be a mode of the keyboard in which a single activation of an alphabetical key in the mode causes the input of only one predetermined character, and repeated activations of the same key continues to input the same predetermined character, even if these repeated activations occur rapidly in sequence. In full keyboard mode, each of a set of alphabetic keys is associated with only one alphabetic character (which is different from keys on a phone's keypad, wherein a single key is typically associated with two or more alphabetic characters—e.g. the “5” key on the phone's keypad is associated with the alphabetic characters “J”, “K” and “L”).

In the full keyboard or PDA position illustrated in FIG. 2B, the mobile voice phone features such as earpiece 216 and microphone 218 may be inactivated. However, keys of phone keypad 224 form part of the key layout 222 of keyboard assembly 220. In one embodiment of the present invention, key layout 222 may be arranged in a conventional QWERTY arrangement, and may also be centered with respect to the relative position of display screen 212. Key layout 222 may also be a thumb-style keyboard such that a user may quickly and accurately enter data using one or both thumbs. This resembles the manner of data entry commonly used on Research In Motion's BlackBerry. “QWERTY” is indicative of the keyboard layout in that the first six letters of the top row, in a direction from left to right, are Q-W-E-R-T-Y. In one embodiment, the thumb-style key layout may have a center-to-center spacing of about 8 mm. A thumb-style key layout 222 allows a user to enter data quickly and accurately.

In one embodiment of the present invention, thumb-style keyboard array 222 may have keys that are disposed about 8 mm apart to provide sufficient spacing for accurate typing by preventing multiple keys from being pressed simultaneously. Each key of thumb-style keyboard array 222 may be structured to provide a certain amount of travel and a tactile feedback to provide feedback to a user that the desired key has been pressed. Each key may provide a tactile feedback by using an over the center buckling action of a dome under the key, thereby allowing a user to detect that a key has been pressed, no matter what portion of the key is actually touched. Alternatively, the feedback may be in the form of a “click” sound generated electronically by the system when the key is pressed.

In another alternative of the present invention, thumb-style keyboard array 222 may have a non-mechanical structure (i.e., no key travel) and be more akin to a membrane-type of keyboard in which each key includes a conventional membrane switch. In a membrane keyboard, the keys use at least one plastic membrane. The membrane is imprinted with a pattern that, when touched by a key, acts like the switch in a mechanical keyboard and sends the “key depressed” signal to the computer or processing system or phone subsystem. Each key may be flush or slightly below the top surface of keyboard assembly 220.

Display screen 212 area may be maximized on display assembly 220. In one embodiment of the present invention, display screen 212 may have a display screen size of 240 pixels (length 215)×160 (width 217) pixels to provide a very comfortable and enlarged display for a user. Other sizes are also possible; for example, the display screen size may have a length of 320 pixels and a width of 240 pixels. The actual size of pixels in the display may be, for each pixel, in the range of about 0.4 mm to about 0.1 mm. Higher resolutions (with smaller pixels) may also be used.

FIG. 2C illustrates portable communication device 200 in a closed position. From this perspective, device 200 has a front side 201, a right side 202, a left side 203, a backside 204, a top side 213, and a bottom side (not shown). The display assembly 210 and the keyboard assembly 220 are protected within the interior of the device 200. First hinge 232 overlaps a portion of display assembly 210 near top side 213. In the closed position, display assembly 210 is rotated over keyboard assembly 220. The dimensions of the keyboard and display assemblies are substantially similar such that in this closed position, display assembly 210 appears to stack on top of keyboard assembly 220 with all edges and corners flush with each other. As such, device 200 in a closed position forms a compact housing that protects the display screen 212 and key layout 222 when the device is not in use or is being transported. Because of the small form factor formed by device 200 in the closed position, it may be placed in a pant pocket or belt holster without being cumbersome and conspicuous. In one embodiment of the present invention, device 200 has a length 240 of about 94 mm and a width 242 of about 48 mm in the closed position (and each of the display and keyboard assemblies have about the same length and width as shown in FIG. 2C). Keyboard assembly 220 has a thickness 270 of about 15 mm and display assembly 210 has a thickness of about 8 mm. FIG. 2D illustrates display assembly 210 partially open relative to keyboard assembly 220 with first hinge 232. This is an intermediate position before rotating open to form the mobile voice phone position as illustrated in FIG. 2A. In one embodiment of the present invention, display assembly 210 may rotate up to about 180 degrees relative to keyboard assembly 220 about first hinge 232.

FIG. 2E illustrates another intermediate position for device 200 as display assembly 210 rotates about second rotating hinge 234 to form the PDA or full keyboard position illustrated in FIG. 2B. Second rotating hinge 234 is disposed near a corner of keyboard assembly 220 and allows display assembly 210 to rotate in a plane parallel to keyboard assembly in the directions of the arrows shown. In one exemplary embodiment of the present invention, display assembly 210 does not rotate about second rotating hinge 234 unless display assembly 210 has first rotated open about first hinge 232 to a position that is substantially parallel (i.e., at least 180 degrees) with keyboard assembly 220. As such, to form the full keyboard or PDA position, device 200 must first form the mobile voice phone position. In the full keyboard or PDA position, an edge along a length 244 of display assembly 210 aligns with an edge along a length 220 of keyboard assembly 210 (an example of this alignment is shown in FIG. 2B).

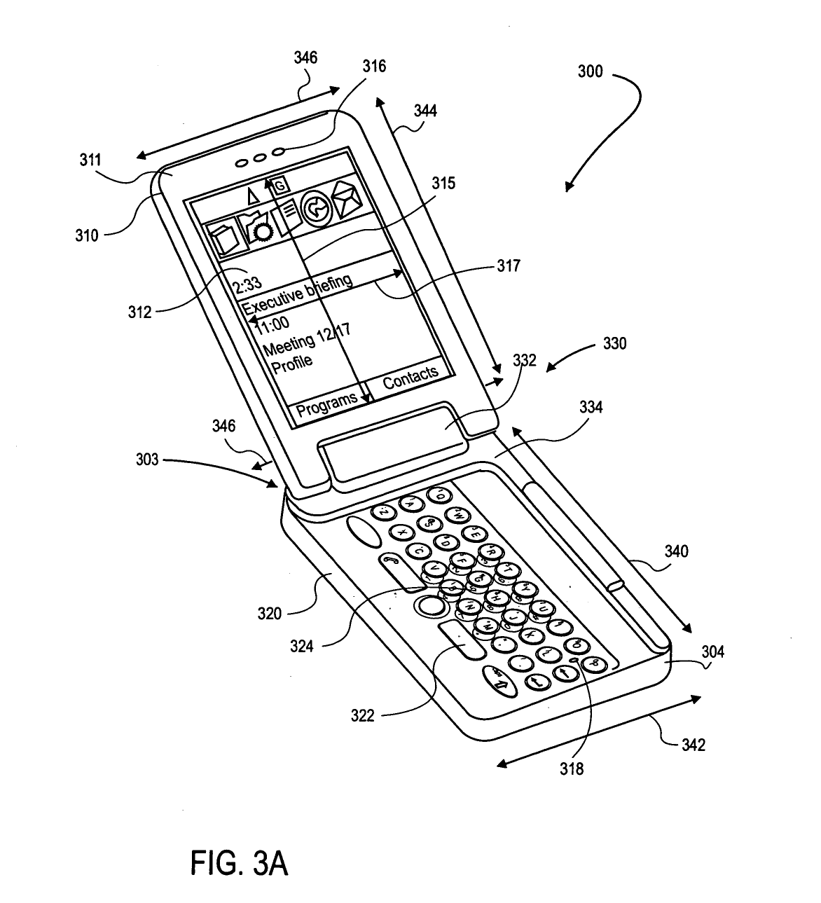

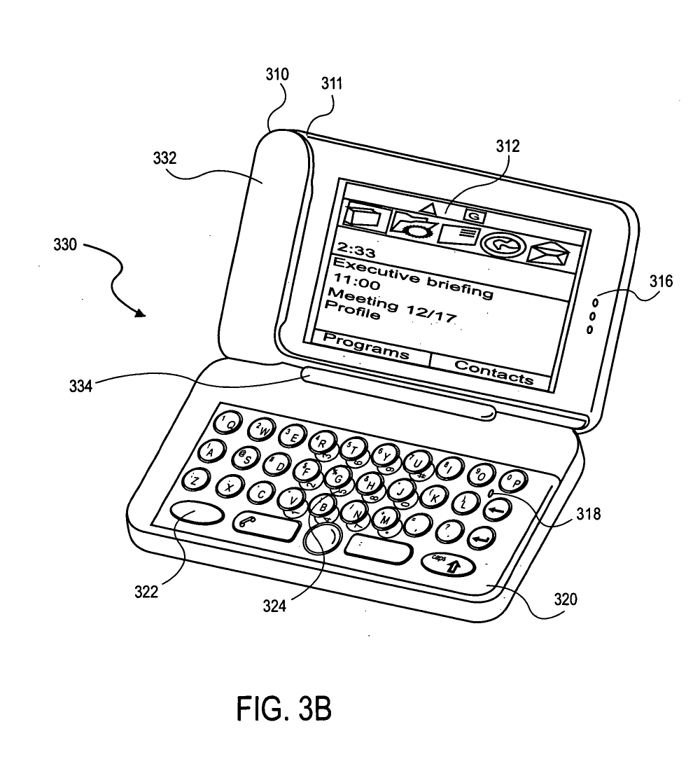

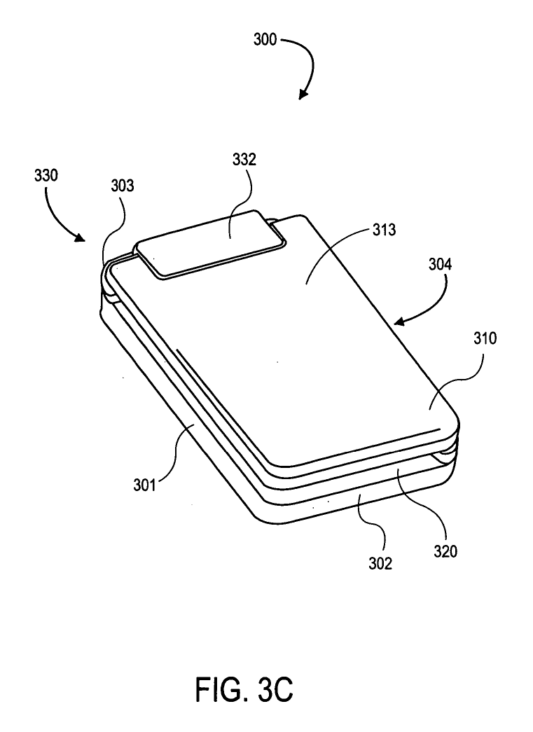

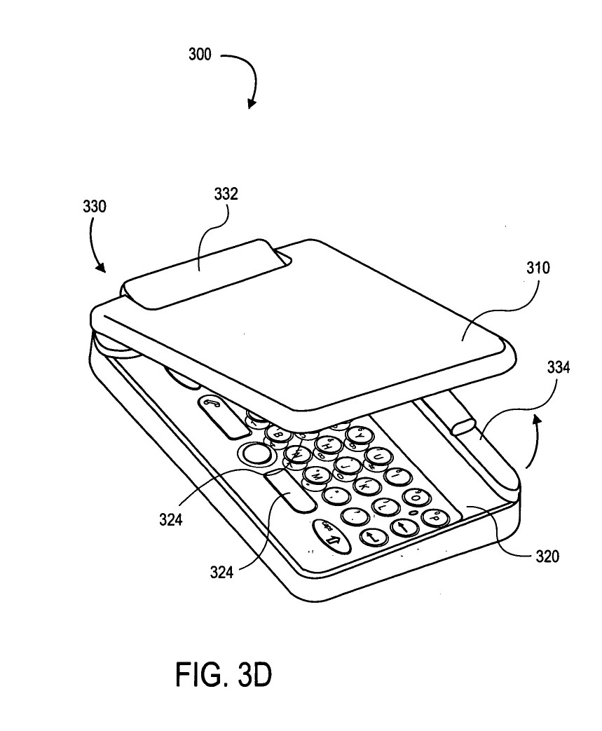

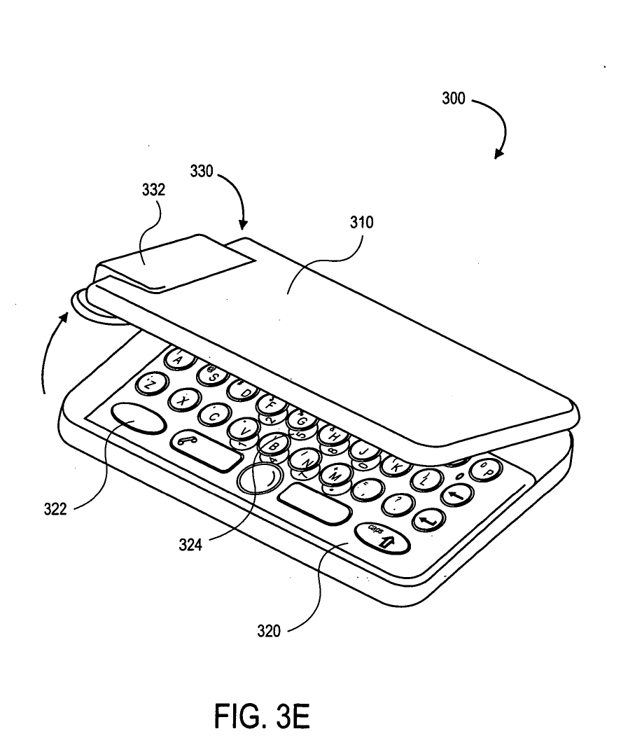

FIGS. 3A-3E illustrate another embodiment of the present invention in which a portable communication device 300 alternates between at least two open positions to form a mobile voice phone position and a full keyboard or PDA position. FIG. 3A illustrates device 300 in a mobile voice phone position with display assembly 310 rotated open (at an angle of less than 180° but more than 90°) relative to keyboard assembly 320. Hinge assembly 330 couples display assembly 310 to keyboard assembly 320. Hinge assembly 330 includes a first hinge 332 disposed near a left edge 303 and a second hinge 334 disposed near a back edge 304 of keyboard assembly 320. As discussed in greater detail below, first hinge 332 and second hinge 334 allow display assembly 310 to rotate open relative to keyboard assembly 320 into different orientations, one to form a mobile voice phone position and a second to form a full keyboard or PDA position.

In the mobile voice phone position illustrated in FIG. 3A, display assembly 310 is rotated about first hinge 332. This mobile voice phone position is comparable to a flip style or clamshell style mobile voice phone, with earpiece 316 disposed on display assembly 310 and microphone 318 disposed on keyboard assembly 320. Display assembly 310 also includes a frame 311 that borders display screen 312. The positions of earpiece 316 and microphone 318 simulate the relative positions on a conventional telephone handset. The earpiece 316 (which acts as a speaker) may be near the upper end of display assembly 310 as shown in FIG. 3A, and the microphone 318 may be near the lower end of the keyboard assembly 320 as shown in FIG. 3A. In one embodiment of the present invention, the mobile voice phone position formed by portable communication device 300 has the size and look and feel of a conventional clamshell style cellular phone—that is, the mobile voice phone position simulates a phone handset. Keyboard assembly length 340 and display assembly length 344 have a combined length (e.g. about 170-200 mm in length in one exemplary embodiment) to position ear piece 316 near a user's ear and mouthpiece 318 comfortably near a user's mouth. Keyboard assembly width 342 and display assembly width 346 are smaller than lengths 340, 344 to provide a long, narrow body that may be held comfortably with the user's fingers or palm. Display assembly 310 also rotates open to an angle between about 100 to about 175 degrees relative to keyboard assembly 320. This angled orientation is better suited for the contoured shape of a user's head from ear to mouth, thereby providing comfort and aesthetics. In one particular exemplary embodiment, the angle may be about 155 degrees.

Any image displayed on display screen 312 in the voice phone mode is oriented in a portrait mode (i.e., text or image is viewed across the shorter display width 317 relative to the display length 315). A key layout 322 is disposed on a top surface of keyboard assembly 320, with a phone keypad 324 which is also integrated with the keys of key layout 322. In one embodiment of the present invention, certain keys of key layout 322 double as phone keypad 324 when in the mobile voice phone position. Although phone keypad keys 324 would be used primarily in the mobile voice phone position, the other keys of keyboard array 322 may also be functional. In an alternative embodiment of the present invention, the keys that form phone keypad 324 may be illuminated when in the mobile voice phone position to distinguish from the non-phone keypad keys which are not illuminated in the mobile voice phone position.

FIG. 3B illustrates portable communication device 300 in a second open position; specifically, display assembly 312 is rotated open relative to keyboard assembly 320 with second hinge 334 of hinge assembly 330. Second hinge 334 is disposed along a length 340 of keyboard assembly 320. In one embodiment of the present invention, this second open position forms a PDA or full keyboard mode. First hinge 332 is part of display assembly 310 and separates from keyboard assembly 320 in the PDA position. Second hinge 334 is integrated with keyboard assembly 320. In one embodiment of the present invention, first hinge 332 and the second hinge 334 may be a continuous, unitary piece that forms hinge assembly 330.

An image on display screen 312 is oriented in a landscape mode. The portrait mode image as illustrated in FIG. 3A has been rotated approximately 90 degrees and reformatted to fit within the landscape screen dimensions. In the PDA position, the mobile voice phone features such as earpiece 316 and microphone 318 may be inactivated. However, keys of phone keypad 324 form part of the key layout 322 of keyboard assembly 320. In one embodiment of the present invention, keys in key layout 322 may be arranged in a conventional QWERTY arrangement, and may also be centered with respect to the relative position of display screen 312. Key layout 322 may also be a thumb-style keyboard such that a user may quickly and accurately enter data using one or both thumbs. In one embodiment of the present invention, thumb-style keyboard array 322 may have keys that are disposed about 8 mm apart to provide sufficient spacing for accurate typing by preventing multiple keys from being pressed simultaneously. Each key of thumb-style keyboard array 322 may be structured to provide a certain amount of travel to provide tactile feedback to a user that the desired key has been pressed. Alternatively, the feedback may be in the form of a “click” sound generated by the system when the key is pressed. In another alternative embodiment of the present invention, thumb-style keyboard array 322 may have a non-mechanical structure (i.e., no key travel) and be more akin to a membrane-type of keyboard in which each key includes a conventional membrane switch. Each key may be flush or slightly below the top surface of keyboard assembly 320.

FIG. 3C illustrates portable communication device 300 in a closed position. From this perspective, device 300 has a front side 301, a right side 302, a left side 303, a backside 304, a top side 313, and a bottom side (not shown). First hinge 332 overlaps a portion of display assembly 310 near top side 313. In the closed position, display assembly 310 is rotated over keyboard assembly 320. The dimensions of the keyboard and display assemblies are substantially similar such that in this closed position, display assembly 310 appears to stack on top of keyboard assembly 320 with all edges and corners flush with each other. As such, device 300 in a closed position forms a compact housing that protects the display screen 312 and key layout 322 when the device is not in use or is being transported. Because of the small form factor formed by device 300 in the closed position, it may be placed in a pant pocket or belt holster without being cumbersome and conspicuous. FIG. 3D illustrates display assembly 310 partially open relative to keyboard assembly 320 with first hinge 332. This is an intermediate position before rotating open to form the mobile voice phone position as illustrated in FIG. 3A. In one embodiment of the present invention, display assembly 310 may rotate up to 180 degrees relative to keyboard assembly 320 about first hinge 332. FIG. 3E illustrates display assembly 310 partially open relative to keyboard assembly 320 with second hinge 334. This is an intermediate position before rotating open to form the PDA position as illustrated in FIG. 3B. In one embodiment of the present invention, display assembly 310 may rotate up to 180 degrees relative to keyboard assembly 320 with second hinge 334. In one embodiment of the present invention, a display controller may be disposed in first hinge 332 and second hinge 334. The display controller may detect the direction or hinge about which display assembly 310 rotates open with respect to keyboard assembly 320. For example, rotating open display assembly 310 about first hinge 332 to form the mobile voice phone position would orient an image on display screen 312 in a portrait mode. Alternatively, rotating open display assembly 310 about second hinge 334 to form the PDA position would orient an image on display screen 312 in a landscape mode.

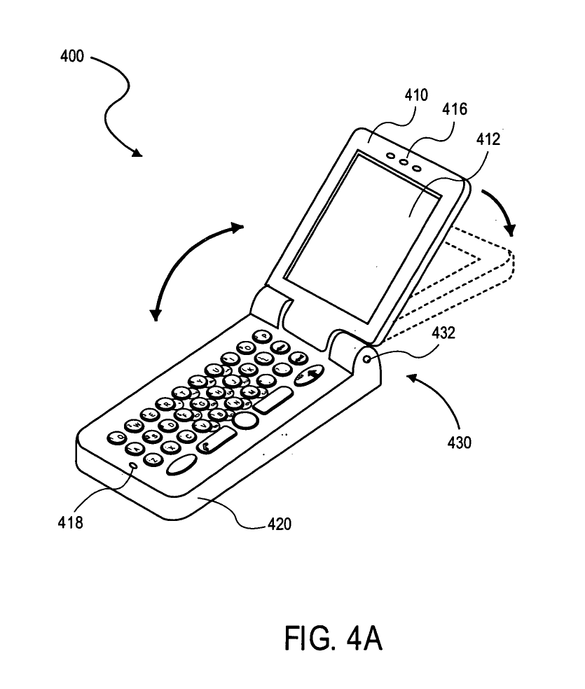

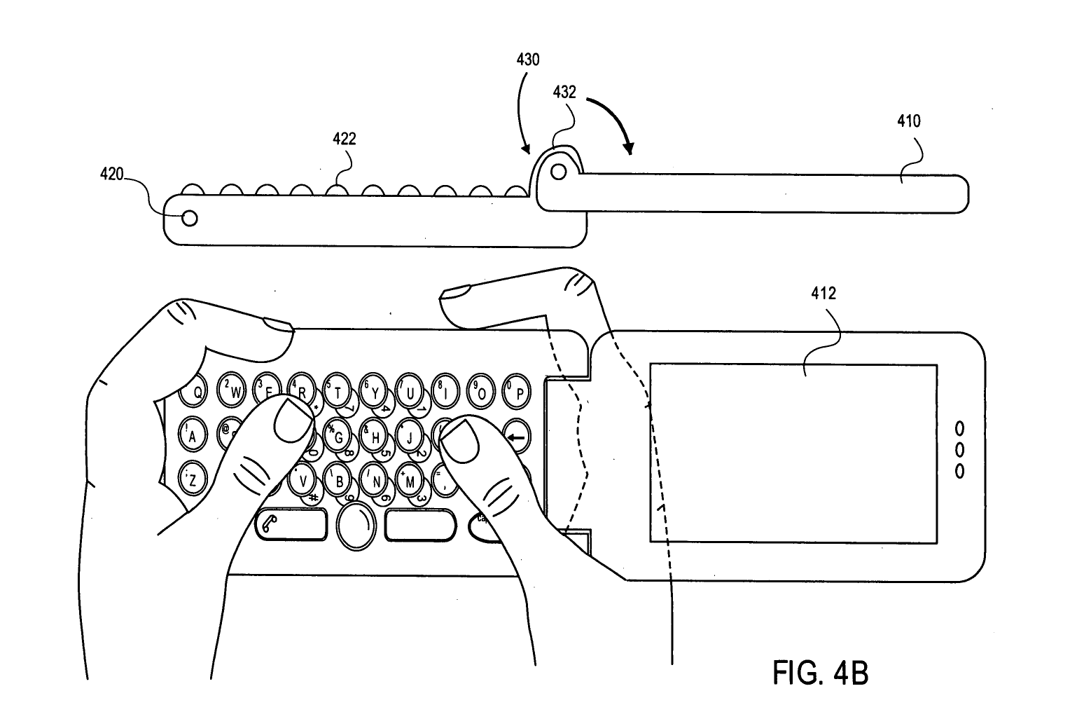

In one embodiment of the present invention, a portable communication device may change from a mobile voice phone mode to a PDA or full keyboard mode by rotating the display from the mobile voice phone position in a direction of rotation which is the same direction used when rotating the device from a closed position to the mobile voice phone position, as shown in FIG. 4A. A controller for display screen orientation may be configured such that text or image is displayed in a landscape mode when the display assembly is rotated past a certain degree of rotation. FIG. 4A illustrates portable communication device 400 with display assembly 410 rotating open from approximately 150 degrees (a voice phone position) to 180 degrees (a full keyboard position) relative to keyboard assembly 420. In one embodiment, device 400 may be similar to device 200 described above and includes an earpiece 416 and a microphone 418. Here, display screen 412 changes and formats text from a portrait mode to a landscape mode when display assembly 410 rotates about hinge 432 of hinge assembly 430 past 175 degrees. In alternative embodiments of the present invention, a controller may be configured to alter the mode of text displayed on display screen 412 at any rotation degree. Alternatively, a detector may be disposed within hinge assembly 430 to detect the degree of rotation of display assembly 410 with respect to keyboard assembly 420. Analogously, the display mode may change from landscape to portrait when display assembly 410 is less than a certain degree relative to keyboard assembly 420. In one embodiment of the present invention, display 412 is in a portrait mode or mobile voice phone mode when the display assembly forms an angle of less than or equal to 160 degrees relative to keyboard assembly 420. Display 412 is in a landscape mode when the display assembly forms an angle of greater than 160 degrees relative to keyboard assembly 420. In the PDA mode illustrated in FIG. 4B, key layout 422 of keyboard assembly 420 is positioned next to (to the left of) display assembly 410, as opposed to below the display assembly (e.g., FIG. 2B). Key layout 422 remains in a comfortable and user-friendly position such that a user's hands can thumb-type with one or both thumbs.

With respect to the devices 200, 300, and 400 discussed above, various wireless technologies may be implemented, including but not limited to Code Division Multiple Access (“CDMA”), Global System of Mobile Communications (“GSM”), General Packet Radio Service (“GPRS”), Bluetooth, and IEEE 802.11 (“WiFi”). Other components may be disposed within either the keyboard assembly or display assembly. In one embodiment of the present invention, components disposed within the keyboard assembly may be coupled to other components in the display assembly using a flex circuit that runs through embodiments of the hinge assembly. In one embodiment of the present invention, the portable communication device may include one or more of hardware and software components found in commercially available notebook computers or PDAs such as a digital camera, MP3 player, or headset jack. A top surface (e.g., top surface 213, 313) may include a second display for showing time/date or calling ID information in the closed position.

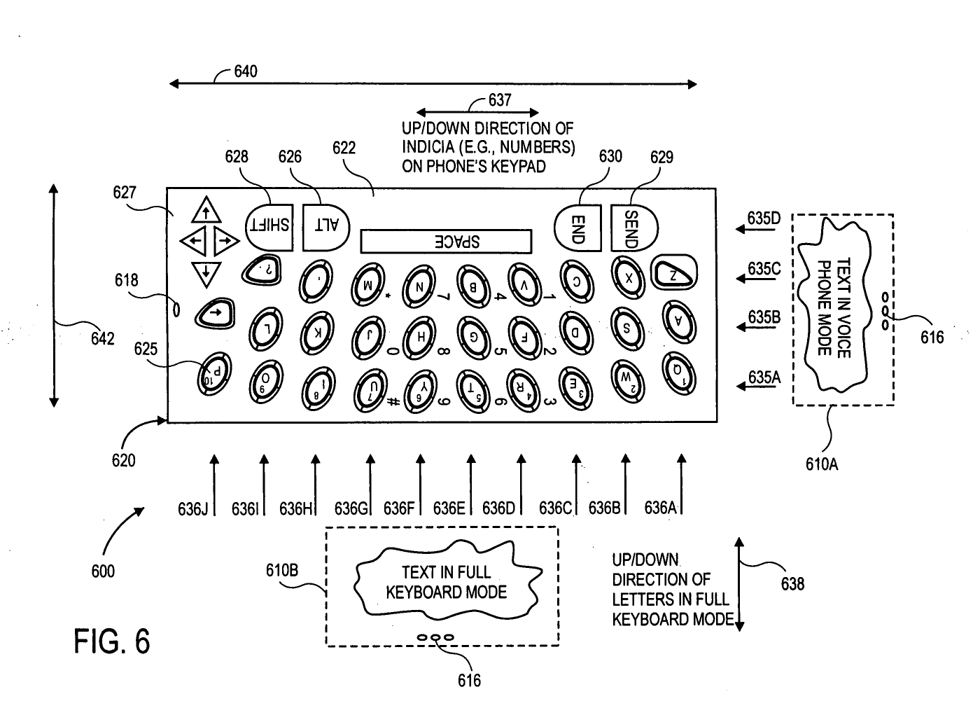

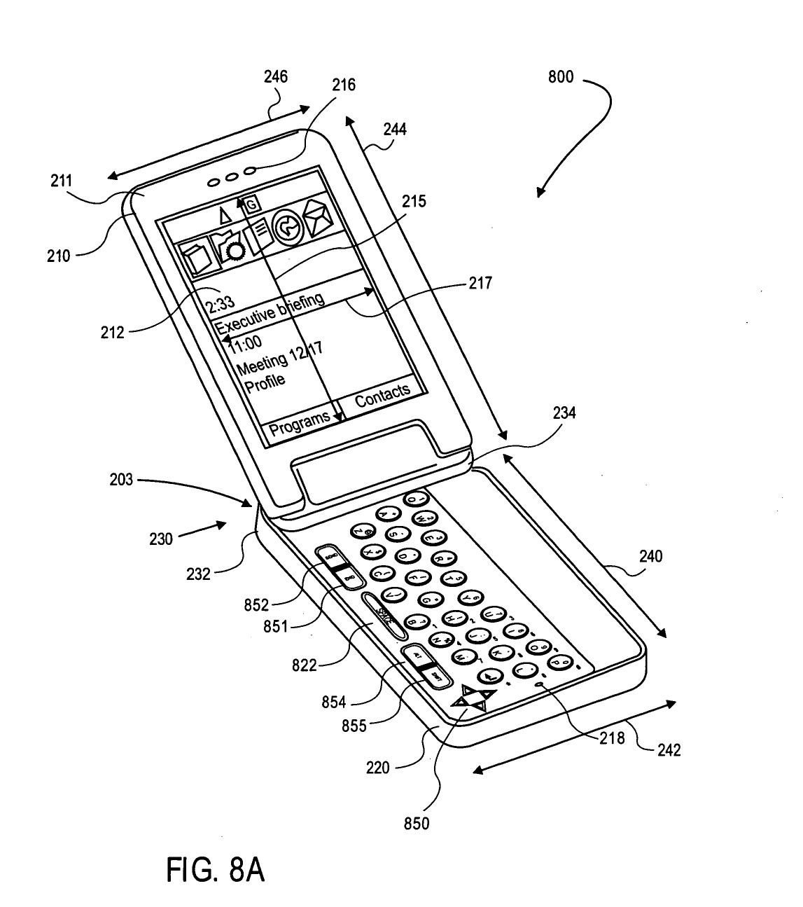

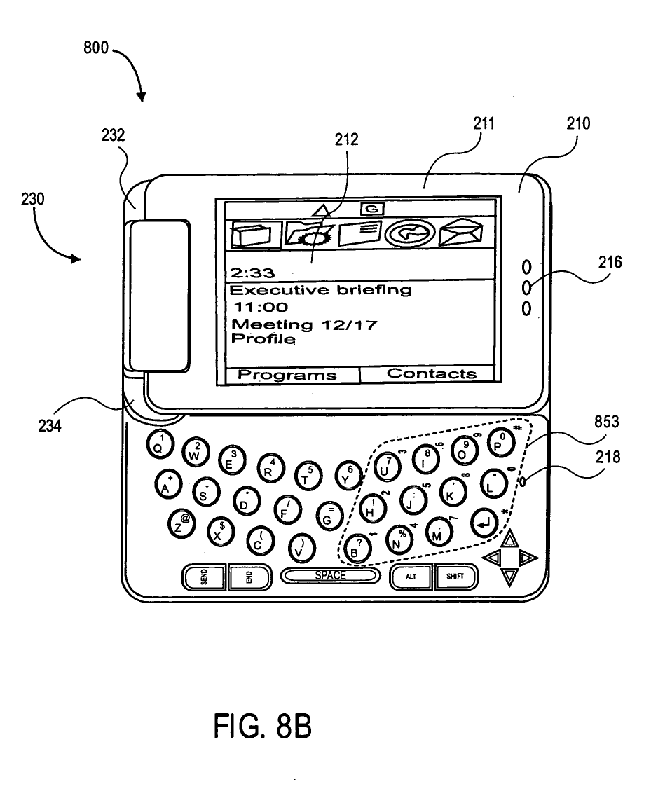

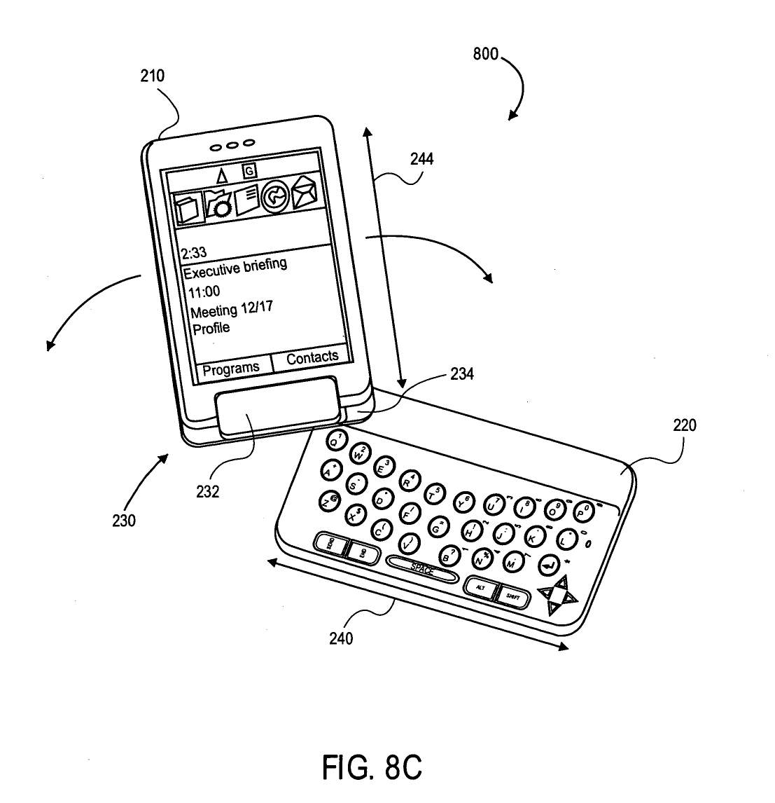

While some of the embodiments described above have an arrangement of keys which are aligned in a nearly perfect linear row and linear column fashion (such as the key arrangement shown in FIG. 5), other key arrangements in which the keys are aligned substantially in rows and columns may also be utilized, such as the arrangement shown in FIG. 6. In the arrangement shown in FIG. 6, the rows are slightly curved while the columns are generally nearly perfectly linear. The arrangement of keys shown in the device of FIGS. 8A-8C shows another example where the rows are slightly curved and the column of keys may be said to be slightly tilted from an orthogonal relationship relative to a long side of the keyboard assembly. The keys in the columns and/or rows may also have a staggered layout, like on a desktop or notebook computer's keyboard.

The keyboard assembly 620 shown in FIG. 6 is part of a device 600 which includes the display assembly 610 shown in two different configurations 610A and 610B. It will be appreciated that the display assembly is coupled to the keyboard assembly 620 using one or more hinges or other mechanisms which may be used to couple the display assembly to the keyboard assembly. The keyboard assembly 620 includes a microphone 618 which is disposed at a lower, central portion of the keyboard assembly 620. The keyboard assembly 620 has a length 640 which is larger than the width 642 such that the keyboard assembly 620 has a long side (length 640) and a short side (width 642). It can be seen from FIG. 6 that the up/down direction 637 of the indicia associated with the phone's keypad is parallel with the long side. It can also be seen from FIG. 6 that the up/down direction 638 of the letters, such as the letter P on the key 625, is parallel to the short side (width 642). The keys are disposed in their arrangement 622 which includes a full alphanumeric keyboard (in this case a QWERTY keyboard) and also includes a phone's keypad, the indicia of which are oriented in a substantially perpendicular manner relative to the indicia on the full alphanumeric keyboard. The key arrangement 622 also includes keys used with alphanumeric keyboards such as the space key and an alternate (Alt) key 626 and a shift key 628 which is used to capitalize a letter. It will be understood that the Alt key is used to select the alternative indicia, such as the numeral 1 rather than the letter Q or the numeral 10 rather than the letter P when the key 625 is depressed or otherwise actuated. Cursor control arrow keys 627 allow for the control of the cursor in either voice phone mode or full keyboard mode. The phone keys 629 and 630 allow for the initiation of a voice phone call or the termination of a voice phone call, respectively. These keys are active during the voice phone mode in which the display 610 is shown in the orientation 610A. The earpiece 616 is disposed in the upper central portion of the display assembly so that the earpiece 616 and the microphone 618 are at opposite ends of the device when it is extended in the long and narrow shape of the voice phone configuration or position. As can be seen from FIG. 6, the text (e.g. a line or row of text) that appears on the display in the voice phone mode (configuration 610A) is parallel with the columns 636A-636J, which columns are formed by the keys in the arrangement of keys 622. The user may switch the device from the voice phone mode to the full keyboard mode by moving the display 610 so that it appears in the orientation shown as display 610B as shown in FIG. 6. In this full keyboard mode, the text appears along rows which are perpendicular to the columns 636A-636J. It can also be seen that the text in the rows of the display shown in the full keyboard mode (configuration 610B) is parallel to the rows 635A-635D, which rows are formed by the keys in the key arrangement 622. It will be appreciated that in certain embodiments which use Asian characters (which may be oriented to read from top to bottom rather than from left to right), a row or line of text in Asian characters will appear, in voice phone mode, to be perpendicular to the columns 636A-636J, and another row or line of text in Asian characters in full keyboard mode will appear to be parallel to the columns 636A-636J.

FIGS. 8A, 8B and 8C show an alternative embodiment of a portable communication device, which embodiment is similar to the device shown in FIGS. 2A-2F except that a different key arrangement 822 is used on the keyboard assembly 220. This key arrangement includes a voice phone keypad 853 which includes a second set of indicia (including the numerals 0-9 for the voice phone's keypad, as well as the “*” and the “#”). As can be seen from FIGS. 8B, 8C and 8A, this second set of indicia is perpendicular to the orientation of the indicia for the full alphanumeric keyboard, which in this case is a full alphanumeric QWERTY keyboard. The keyboard also includes a space key and an alternate (Alt) key 854 and a shift key 855. Arrow cursor control keys 850 allow for the control of the cursor in at least full text mode and also optionally voice phone mode. Send key 852 and End key 851 are used in the voice phone mode for initiating and terminating a voice phone call. It can be seen from the arrangement of keys shown in FIGS. 8A-8C that there are two sets of indicia which are oriented substantially perpendicular relative to each other and which exist on a single, unitary keyboard assembly which may be covered and thereby protected when the display assembly 210 is closed in the manner shown in FIG. 2C. When the keyboard is not covered by the display, it is fully accessible and not partially covered. Thus, the embodiment shown in FIGS. 8A-8C has a closed position which is similar to that shown in FIG. 2C as well as having a first open position which is a voice phone mode position shown in FIG. 8A as well as a full keyboard position or mode shown in FIG. 8B. FIG. 8C shows the position of the display assembly 210 relative to the keyboard assembly 220 when the display assembly is being moved between these two modes.

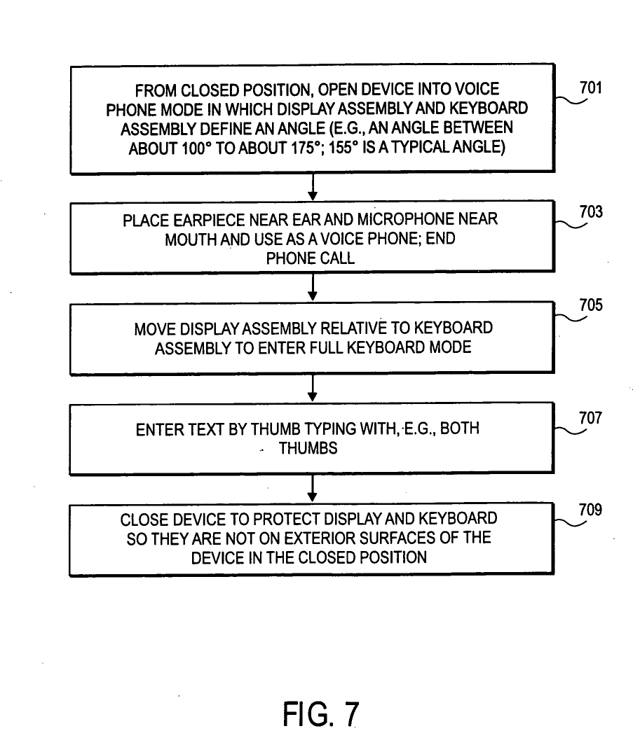

A method for using one or more of the various devices described herein will now be provided with reference to FIG. 7. In operation 701 of FIG. 7, a user opens the device from a closed position. The device is opened into a voice phone mode in which the display assembly and the keyboard assembly define an angle between the two assemblies. In a typical embodiment the angle may be about 155 degrees. The user then, in operation 703, places the earpiece near the user's ear and the microphone near the user's mouth and uses the device as a voice phone. Upon completion of a conversation, the phone call is ended and the user decides to move the display assembly relative to the keyboard assembly to enter a full keyboard mode. Thus, the user may move the display assembly 210 shown in FIG. 2A from the position shown in FIG. 2A to the position shown in FIG. 2B to thereby enter full keyboard mode in operation 705. Then in operation 707, the user enters text by thumb typing with one or both thumbs on the keyboard assembly. Alternatively, other fingers or a thumb and other fingers may be used to type on the keyboard. Upon completion of the desired tasks in full keyboard mode (e.g. sending an email or sending an instant message or entering a date in a calendar or an address in an address book or other uses which may occur in a keyboard mode), the user then decides to close the device (in operation 709) to protect the display and the keyboard so that they are not on an external surface of the device when it is in the closed position. One example of the closed position is shown in FIG. 2C.

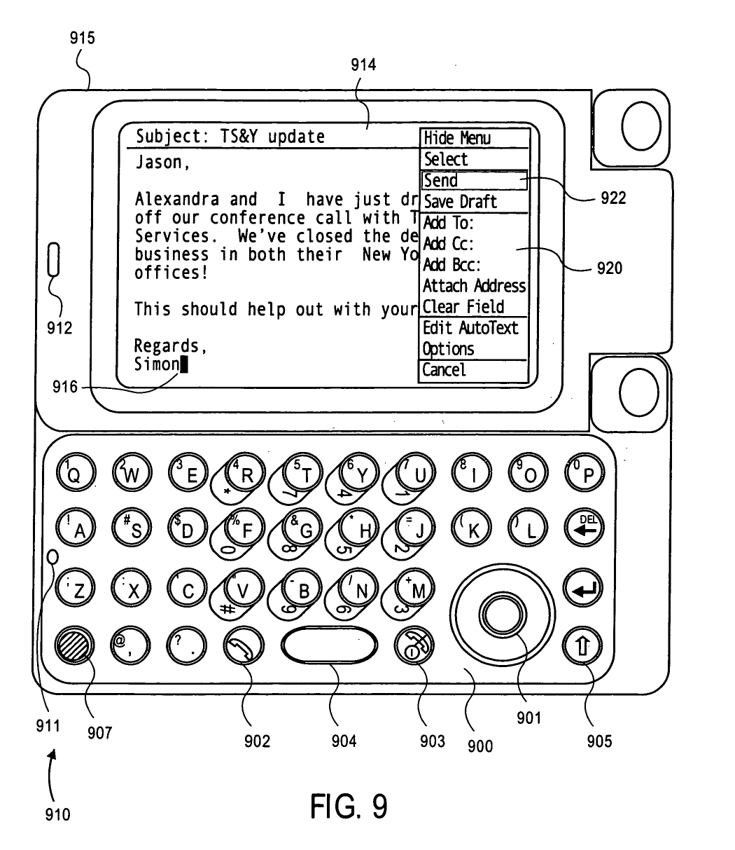

FIG. 9 shows a top view of an alternative embodiment of a portable communication device of the present invention. This device 910, shown in a full keyboard mode in FIG. 9, has an alternative keyboard layout 900 which includes phone keys 902 (e.g. “send”) and 903 (e.g. “end”) to start and end a phone call, and a cursor controller 901 (which may be used like a mouse or trackpad to control the two-dimensional movement of a cursor on the display 914) and conventional full keyboard keys such as a space key 904 and a shift key 905 (e.g. for selecting a capital letter). The keyboard 900 includes an alternate key 907 which may be used to select an alternate function for one or more keys. For example, in full keyboard mode, an exclamation mark (“!”) may be typed by pressing the key 907 and then pressing the “A” key. If the key 907 is not pressed while or immediately prior to pressing the “A” key, then a press of the “A” key results in the input of an “A” (a lowercase “a” if key 905 is not pressed or an uppercase “A” if key 905 is pressed). The keyboard assembly also includes a microphone 911 for use in at least the voice phone mode, although the microphone may also be used in full keyboard mode (e.g. to record a sound or a voice memo which could be saved or sent as an attachment to an email or instant message). The display assembly 915 is shown with its long sides parallel to the long sides of the keyboard assembly; the display assembly includes a display 914 and an earpiece (e.g. a speaker) which may be used in phone mode for a phone call or in full keyboard mode to play back or listen to sounds (e.g. a voice memo or voicemail). An email user interface is shown on the display 914. This email user interface includes a menu 920 of possible commands, including a “send” command 922 which is highlighted. A cursor 916 may be positioned by using the cursor controller 901 which may be implanted as a joystick type device or a trackpad or trackball or other known two-dimensional cursor control devices.

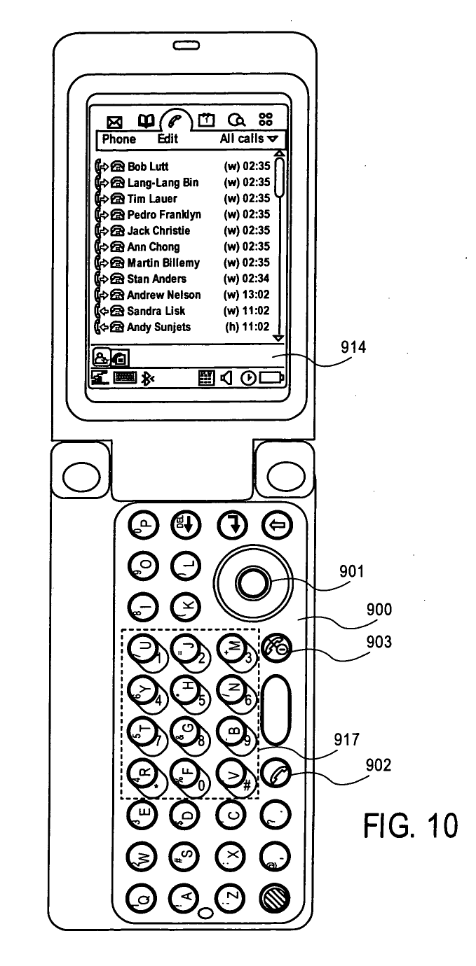

FIG. 10 shows the device 910 in its voice phone mode. Text on the display 914 is now in a portrait mode (unlike the landscape mode of FIG. 9); the display 914 shows an example of a phone list (e.g. phone book) user interface. In this voice phone mode, the keys of the voice phone keypad 917 become active. Thus, pressing the “T” key will normally cause the input of a 7 (unless the user is in a text entry mode while also in voice phone mode, in which case a “T” can be inputted by pressing the “T” key).

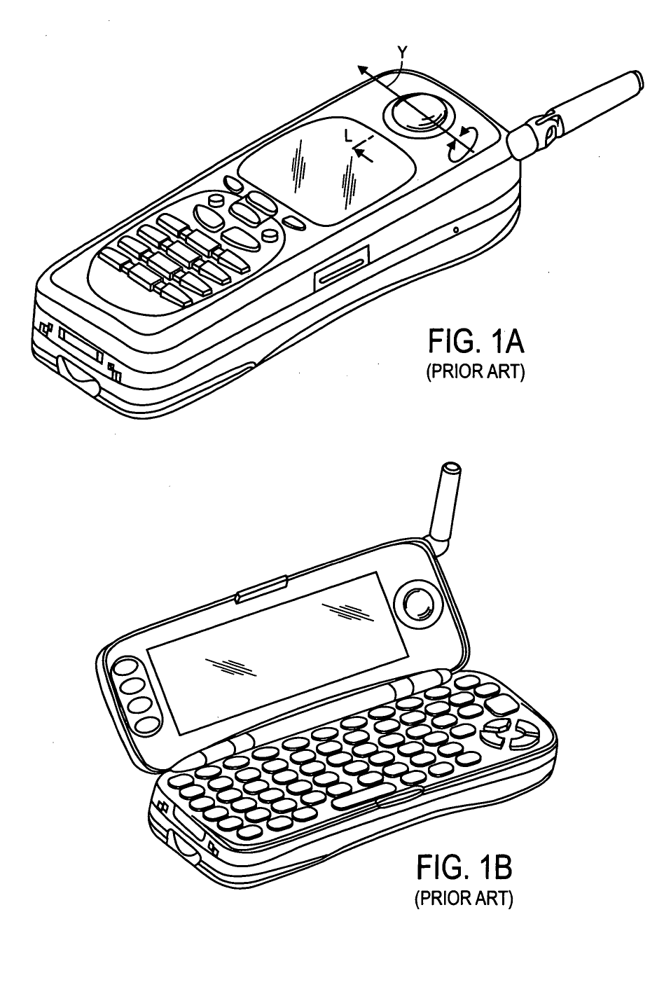

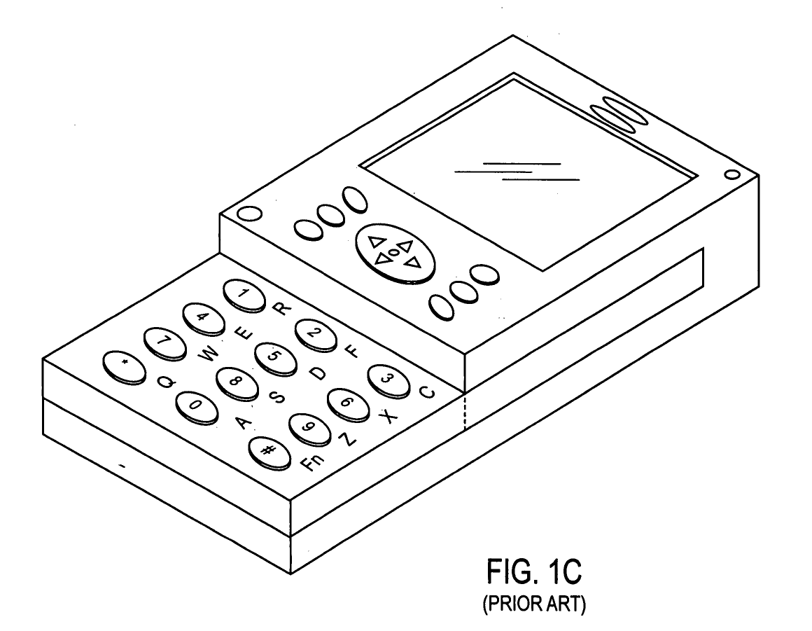

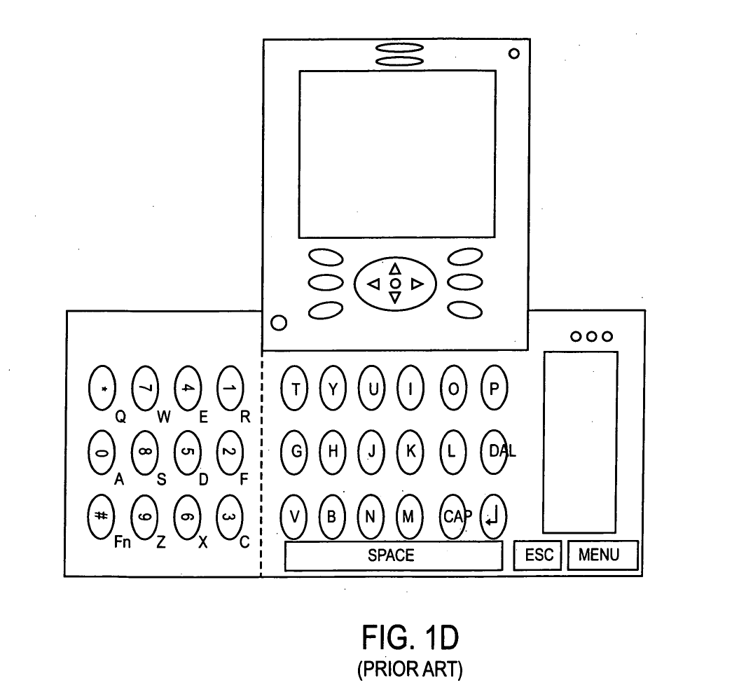

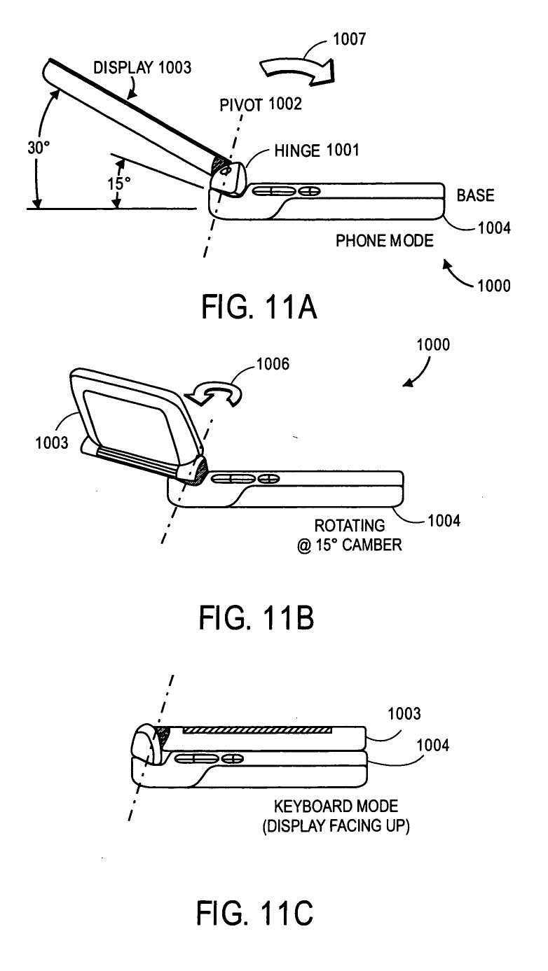

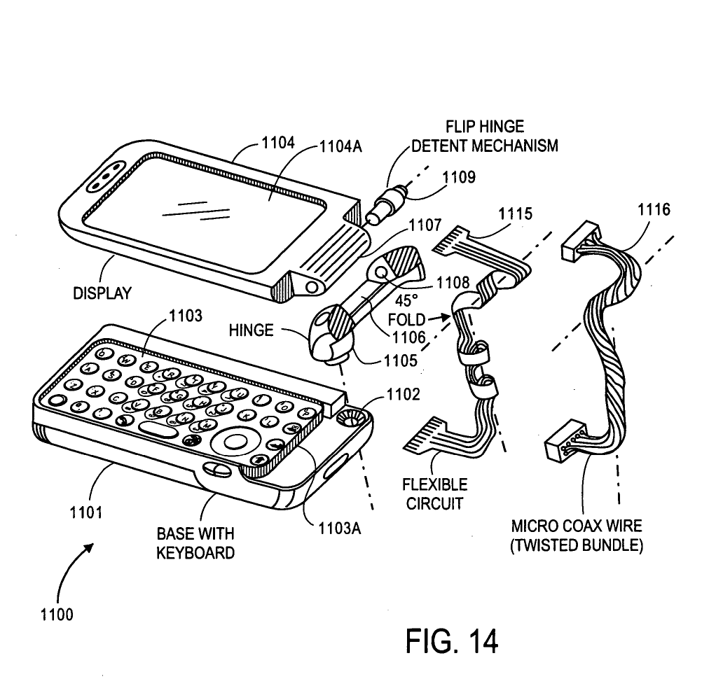

FIGS. 11A, 1B and 11C show side views of a hinge mechanism on an embodiment of a portable communication device of the present invention. A similar embodiment is also shown in FIG. 14. FIG. 11A shows the portable communication device 1000 in a voice phone mode. In this mode, the display assembly 1003 forms an angle of about 150° with the keyboard assembly 1004. A hinge 1001 includes a pivot 1002 which allows the display assembly 1003 to rotate from the voice phone mode (shown, for example, in FIG. 2A) to a full keyboard mode (shown, for example, in FIG. 2B). The pivot 1002 is about 15° from vertical in this example. FIG. 11B shows the display assembly 1003 as having been partially rotated in the direction of arrow 1006 between the phone mode of FIG. 11A and the full keyboard mode of FIG. 11C. The hinge 1001 also allows the display assembly 1003 to be rotated, relative to the keyboard, from its open position in FIG. 11A to a closed position (by pushing the display assembly 1003 in the direction of arrow 1007) so that the display and the keyboard face each other (e.g., see FIGS. 2D and 2C).

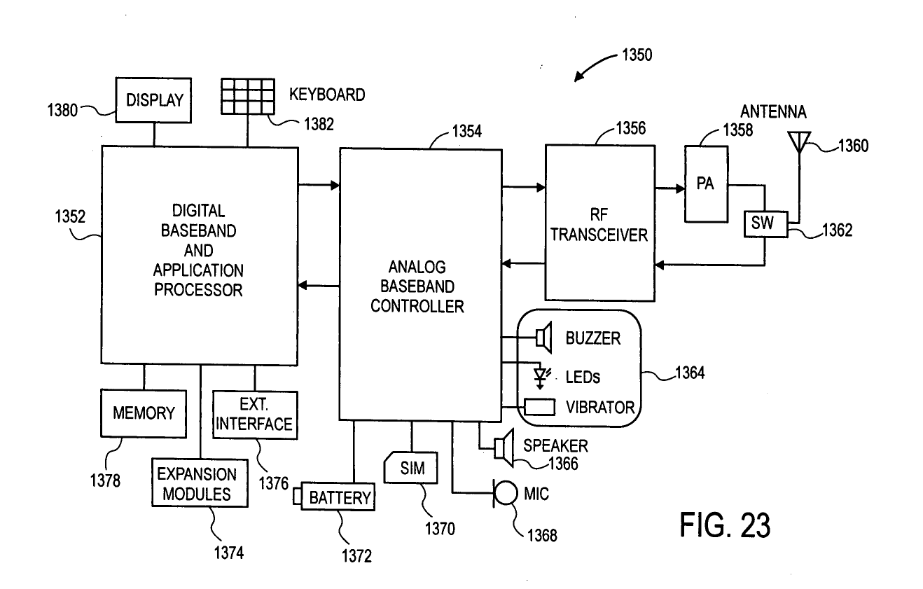

The embodiment of FIG. 14 is similar to the embodiment of FIGS. 11A-11C in that the hinge mechanisms of both embodiments allow the display assembly to be rotated to a closed configuration so that the display and keyboard face each other (e.g. see FIGS. 2D and 2C) and also allow the display assembly to be rotated between a phone mode (e.g. see FIGS. 11A and 2A) and a full keyboard mode (e.g. see FIG. 2B). The portable communication device 1100 shown in FIG. 14 includes a keyboard assembly 1101 which has a keyboard 1103 and a display assembly 1104 which has a display 1104A. A hinge mechanism couples the keyboard assembly 1101 to the display assembly 1104, and this hinge mechanism includes a rotating arm which is secured in an opening 1102 of the keyboard assembly 1101. A hinge coupler 1105 engages the opening 1102 and allows the rotating arm to swing between about 0° and about 180° relative to the short side 1103A of the keyboard; at the 0° position (of the rotating arm relative to the short side 1103A), the device is in voice phone mode (with the display being at an angle of about 100° to about 170° relative to the keyboard) and at the 180° position (of the rotating arm relative to the short side 1103A), the device is in full keyboard mode. A display receiving section 1106 on the rotating arm is disposed between the two ends of the rotating arm and is designed to receive a coupler section 1107 which extends from a short side of the display assembly 1104. The coupler section 1107 fits between the two ends of the rotating arm, and at least one axle 1109 fits into a tubular opening 1108 on each end of the rotating arm and also fits within an opening of the coupler section 1107. The axle 1109 couples the display assembly 1104 to the rotating arm and allows the display assembly 1104 to rotate relative to the rotating arm. FIG. 14 also shows two different methods (flexible circuit 1115 or twisted bundle 1116) of electrically coupling the keyboard assembly 1101 (which may include substantially all the electrical components, such as those shown in FIG. 23, except for the display and the speaker) to the display assembly 1104. The flexible circuit 1115 has one end coupled to a connector in the keyboard assembly 1101 and the other end coupled to a connector in the display assembly 1104. There are several loops and a 45° fold in the flexible circuit 1115 between these two ends as shown in FIG. 14. The loops and fold allow the flexible circuit 1115 to be moved with the rotating arm, as it is swung between the 0° to 180° positions, and allow it to be moved when the display assembly 1104 is rotated between closed (e.g. FIG. 2C) and voice phone (e.g. FIG. 2A) positions. A twisted bundle 1116 (which may be formed from micro coax wire) may be used instead of the flexible circuit 1115.

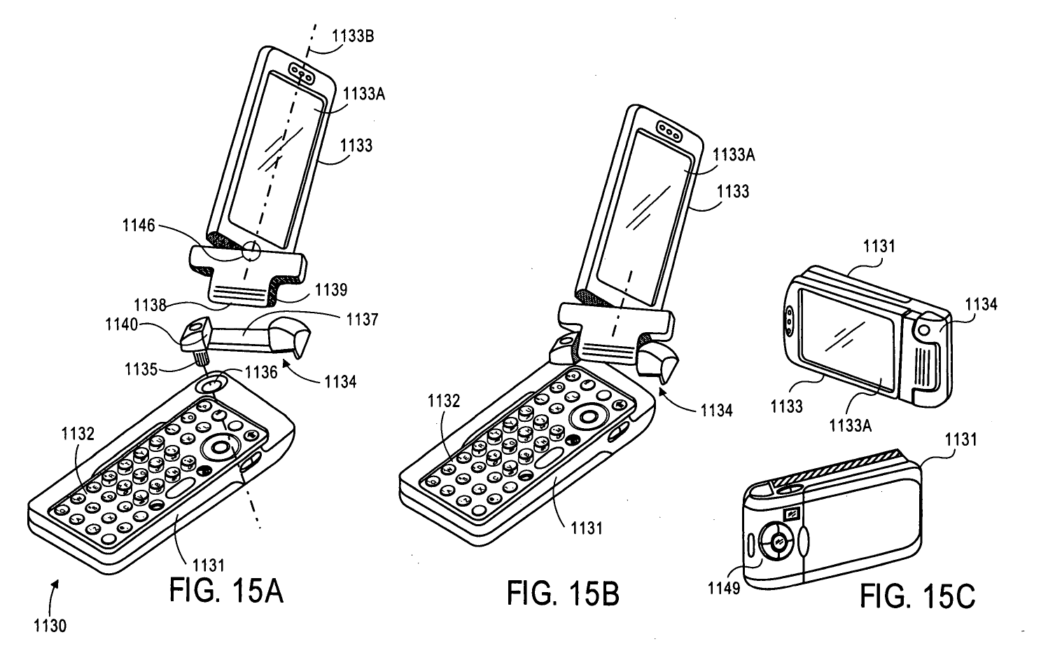

Another exemplary embodiment of a portable communication device is shown in FIGS. 15A-15C. This device 1130 includes a hinge mechanism which is similar to the hinge mechanisms shown in FIGS. 1A-11C and 14. The hinge mechanism 1134 couples the base assembly 1131, which includes a keyboard 1132, to the display assembly 1133, which includes a display 1133A. The hinge coupler 1135 engages the opening 1136 in the keyboard assembly 1131 and allows the rotating arm of the hinge assembly to rotate between about 0° and about 180° relative to a short side of the keyboard 1132. A display receiving section 1137 on the rotating arm is disposed between the two ends of the rotating arm and is designed to receive a coupler section 1138 which extends from a short side of the display assembly 1133. The coupler section 1138 fits between the two ends of the rotating arm, and at least one coupling mechanism 1140 and 1139 rotatably couples the coupler section 1138 to the rotating arm. The coupler section 1138 is rotatably coupled to the display 1133A by a rotatable coupler 1146. This rotatable coupler 1146 allows the display 1133A to be rotated around the axis 1133B shown in FIG. 15A; this allows the display 1133A to be rotated to face outwardly as shown in FIG. 15C which shows the display 1133A on the exterior surface of the device while it is in a closed configuration. The device in this configuration may be used as a camera which has a lens 1149 on the “front” of the device (which is the outside surface of the keyboard assembly 1131). The display 1133A in the closed configuration of FIG. 15C can function as a view finder before taking a picture and can show the result of a taken picture. The display 1133A can also be rotated relative to the keyboard assembly 1131 so that it faces the keyboard in another closed configuration.

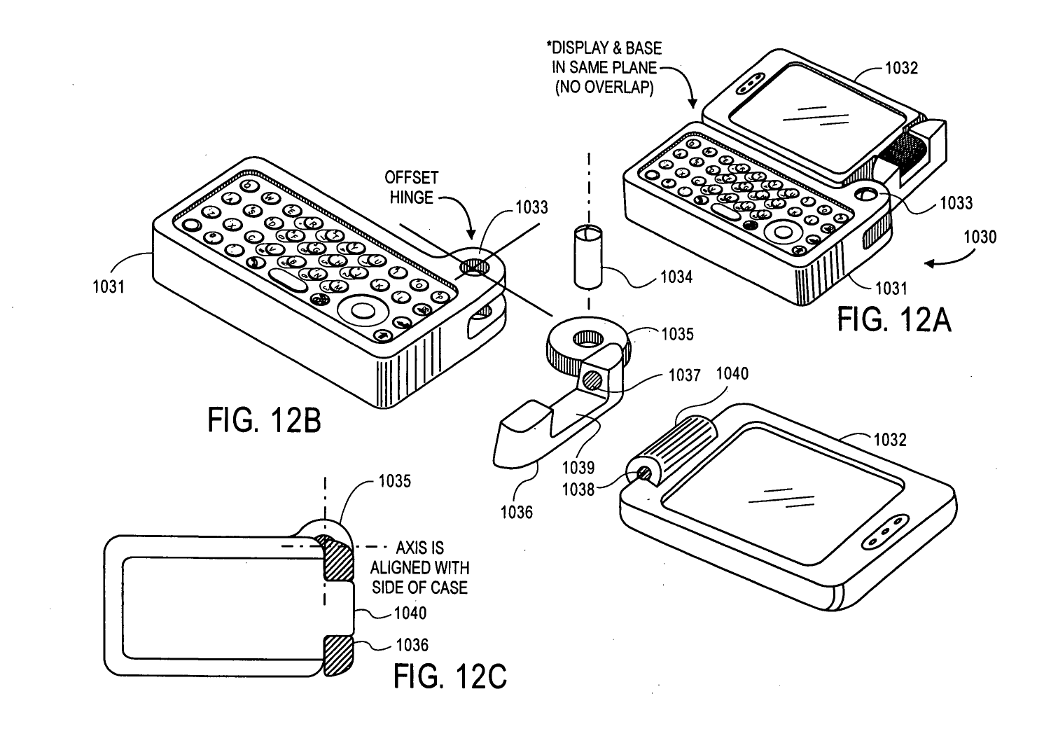

FIGS. 12A, 12B and 12C show another exemplary embodiment of a portable communication device 1030 which uses an offset hinge mechanism. The device 1030, shown in FIG. 12A in a full keyboard mode, includes a keyboard assembly 1031 which includes a keyboard, and a display assembly 1032 which includes a display. The display assembly 1032 is rotatably coupled to the keyboard assembly 1031 by an offset hinge mechanism which includes a rotating arm 1036 that is coupled to a washer-like element 1035. The offset hinge mechanism further includes a frame 1033 which receives a pin 1034 which secures the washer-like element 1035 to the frame 1033 when the pin 1034 is positioned through the aligned holes in the frame 1033 and the washer-like element 1035. The offset hinge mechanism allows the rotating arm and the display assembly 1032 to be rotated between the full keyboard mode shown in FIG. 12A to the voice phone mode shown in the exploded view of FIG. 12B. A coupler section 1040 of the display assembly 1032 couples the display assembly 1032 to the rotating arm 1036. The coupler section 1040 fits in a receiving section 1039 between the two ends of the rotating arm 1036. At least one coupler mechanism 1037 and 1038 rotatably couples the coupler section 1040 (and hence the display assembly 1032) to the rotating arm. FIG. 12C shows a view of how the display assembly and its coupler section 1040 fit within the rotating arm 1036.

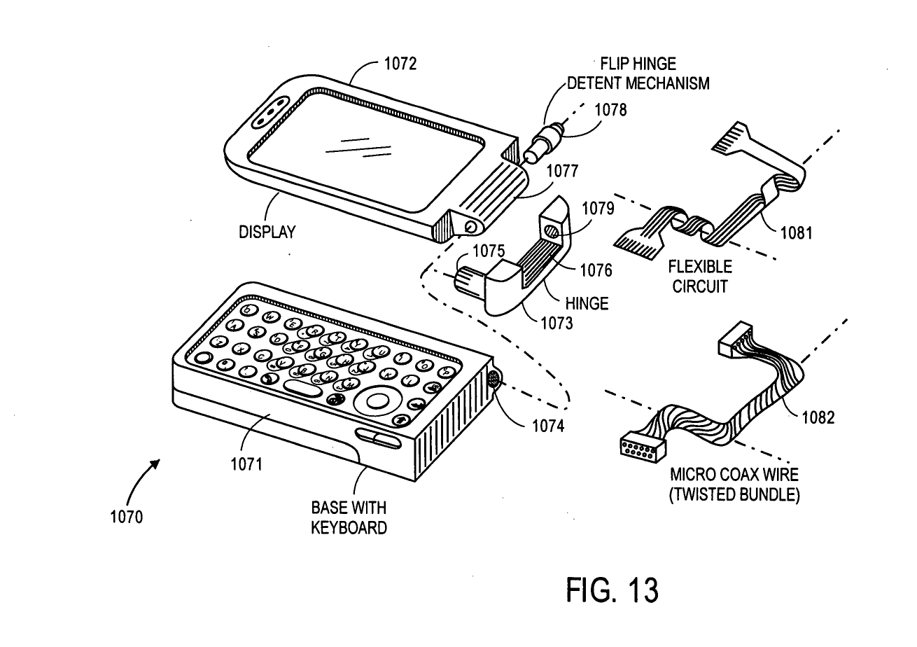

FIG. 13 shows a partially exploded view of another exemplary embodiment of a portable communication device of the present invention. This device 1070 includes a keyboard assembly 1071, which has a keyboard, and a display assembly 1072, which has a display. A hinge mechanism couples the display assembly 1072 to the keyboard assembly 1071. The hinge mechanism includes a rotating arm 1073 which is rotatably coupled to the keyboard assembly 1071 by a post 1075 which protrudes from the rotating arm 1073 and which engages a socket 1074 in the keyboard assembly 1071. The rotating arm also includes a receiving section 1076 which is disposed between the two ends of the rotating arm and is designed to receive a coupler section 1077 of the display assembly 1072. The coupler section 1077 fits between the two ends, and at least one coupling mechanism 1078 and 1079 rotatably couples the coupler section 1077 to the rotating arm. The display assembly 1072 can rotate relative to the rotating arm and the rotating arm (with the display assembly attached thereto) can rotate relative to the keyboard assembly 1071. Thus, the display assembly 1072 can be rotated into a full keyboard mode as shown in FIG. 13 and then can be rotated to a voice phone mode by rotating the display assembly 1072 about 180° around the rotating arm and then the rotating arm can be rotated about 180° (about the pivot formed by post 1075 and socket 1074).

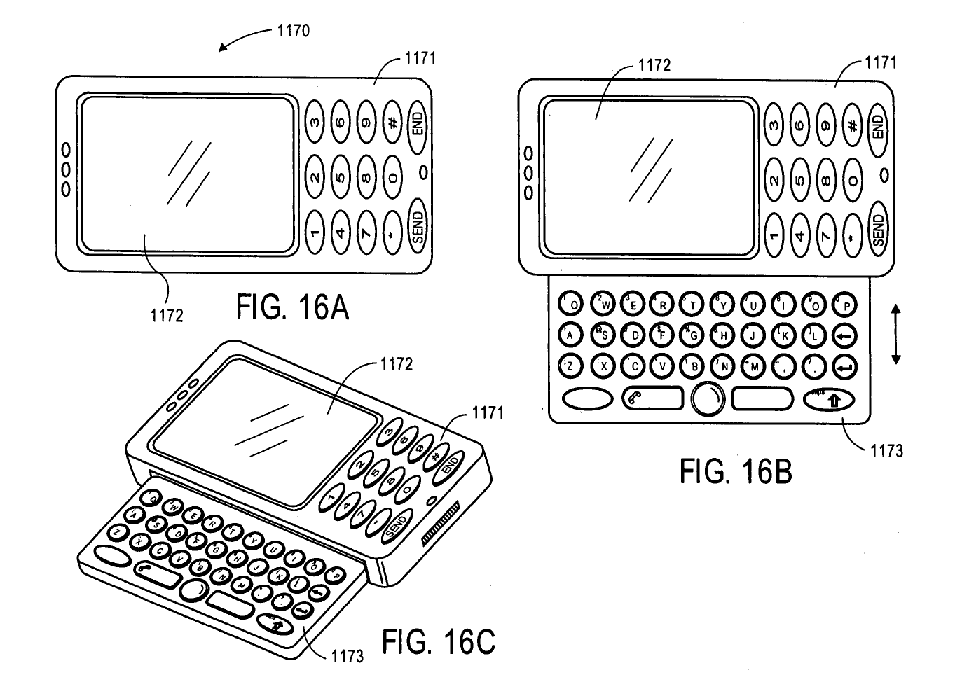

FIGS. 16A, 16B and 16C show another exemplary embodiment of a portable communication device 1170 which uses a slide out full keyboard. The device 1170 includes a display 1172 and a phone keypad 1171 on the same assembly as the display 1172. The device 1170 further includes a microphone and a speaker on this assembly. FIG. 16B shows the full keyboard assembly 1173 after it is retracted from the side of device 1170. This full keyboard 1173 is similar to the full keyboards shown above except that it does not include an integral phone keypad which is perpendicularly arranged relative to the keys on the full keyboard. As shown in FIGS. 16A-16C, a phone keypad 1171 is separate from the full keyboard 1173, and the set of indicia (e.g. 0-9 and “#” and “*” and other additional keys such as “send” and “end” and “menu,” etc.) in this keypad 1171 are oriented perpendicularly to the set of indicia (e.g. A, B, C, ?, etc.) on the keys of the full keyboard 1173. A row of text on the display 1172 in the phone mode (which is the device 1170 shown in FIG. 16A) is oriented parallel to the short sides of the display 1172, which are the sides which are parallel with the up/down direction of the indicia on the keys of the full keyboard 1173. A row of text, on the display 1172, in the full keyboard mode (which is the device shown in FIG. 16C) is oriented perpendicular to the short sides of the display 1172. Thus, the orientation of the text on the display 1172 is different depending on the mode of the device.

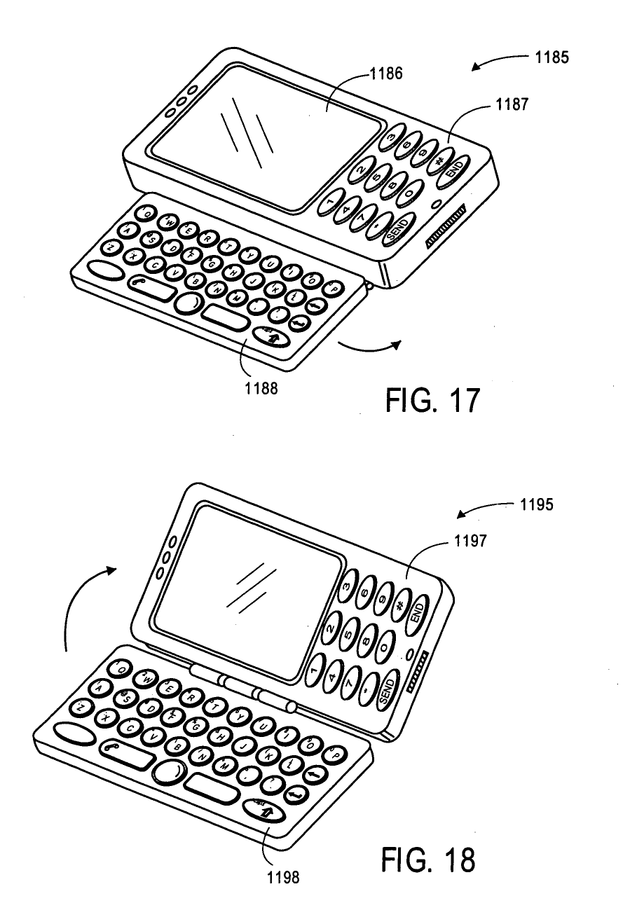

FIGS. 17 and 18 show two other alternative portable communication devices. FIG. 17 shows the device 1185 which is similar to the device 1170 except that the full keyboard 1188 rotates relative to (rather than slides out from) the assembly which includes the display 1186 and the phone keypad 1187 which is separate from the full keyboard 1188. The full keyboard 1188 is coupled to this assembly by a conventional (e.g. piano) hinge. The device 1195, shown in FIG. 18, is similar to device 1185 except that the full keyboard 1198 is coupled to the display assembly 1197 by an “X” hinge. The display assembly 1197 includes both a display and a phone keypad which is separate from the full keyboard 1198. In the case of devices 1185 and 1195, the text on the display will have one orientation in the voice phone mode and another orientation in the full keyboard mode. As shown in FIGS. 17 and 18, the set of indicia (e.g. 0-9 and “#” and “*” and other additional keys such as “send” and “end” and “menu,” etc.) in the phone keypads of devices 1185 and 1195 are oriented perpendicularly to the set of indicia (e.g. A, B, C, ?, etc.) on the keys of the full keyboards 1188 and 1198. A row of text on the displays of devices 1185 and 1195 in the phone mode is oriented parallel to the short sides of the displays, which are the sides which are parallel with the up/down direction of the indicia on the keys of the full keyboards. A row of text on the displays of these devices 1185 and 1195, in the full keyboard mode, is oriented perpendicular to the short sides of the displays. Thus, the orientation of the text on the displays is different depending on the mode of the device.

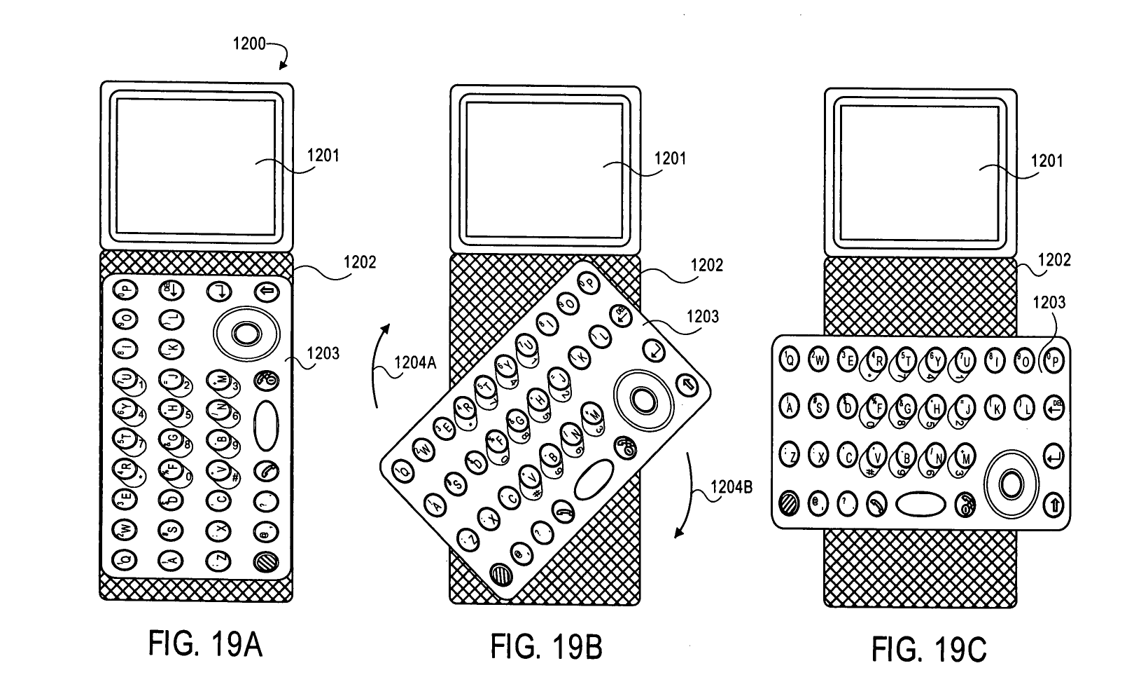

FIGS. 19A, 19B, and 19C show another exemplary embodiment of a portable communication device. The device 1200 shown in the top plan view of FIGS. 19A, 19B and 19C may be implemented as either a candy bar style phone or a clamshell style phone. Also, it may be implemented with either a square or nearly square display (such as the display 1201) or a display which has a 4:3 aspect ratio or other non-square aspect ratios (such as those displays shown in FIG. 2A or 3A or elsewhere). The device 1200 includes a display assembly which has the display 1201 and a base assembly 1202 which is rotatably coupled to a keyboard assembly 1203. FIG. 19B shows how the keyboard assembly 1203 may be rotated (as shown by arrows 1204A and 1204B) relative to base assembly 1202 to achieve the two different operating positions shown in FIGS. 19A and 19C. FIG. 19A shows a voice phone mode in which the up/down direction of the indicia of the phone's keypad is parallel with the long sides of the base assembly 1202, and FIG. 19C shows a full keyboard mode in which the up/down direction of the “QWERTY” keyboard indicia of the full keyboard is parallel with the long sides of the base assembly 1202.

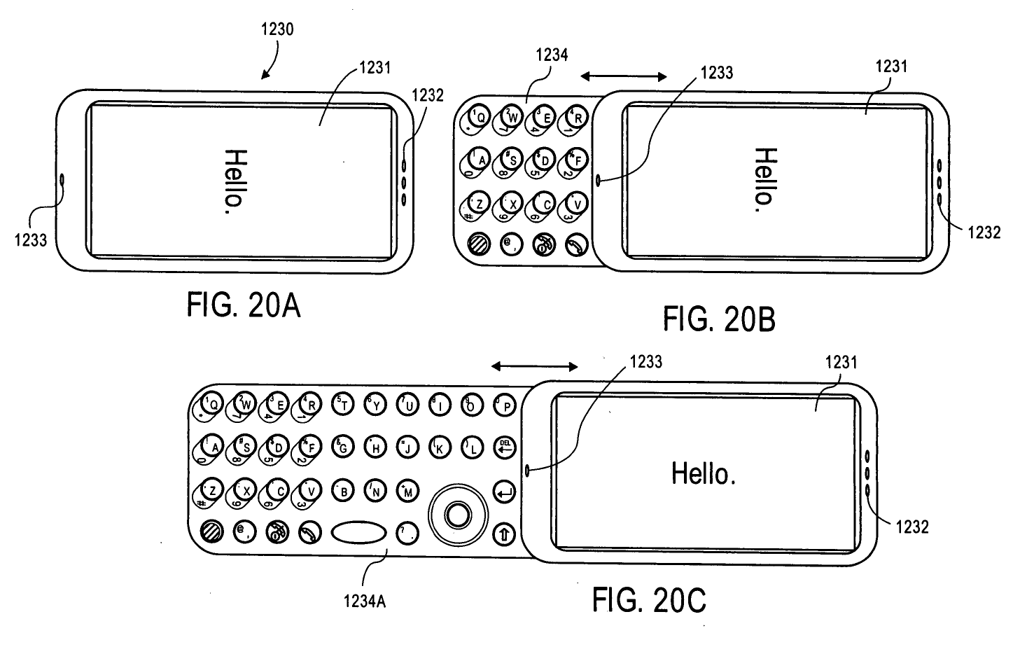

FIGS. 20A, 20B, and 20C show another exemplary embodiment of a portable communication device of the present invention. The device 1230 includes a display 1231 which occupies most of the top surface of the device 1230. The top surface also includes a microphone 1233 and a speaker 1232. FIG. 20A shows, in a top plan view, this top surface of the device 1230 in a voice phone mode wherein a phone keypad has not been extended from a side of the device 1230. The device 1230 may be used in the voice phone mode (e.g. to make and receive phone calls, etc.) without the phone keypad being extended. If the display 1231 is touch sensitive, an activatable phone keypad may be displayed and used on the display 1231 without extending the phone keypad. FIG. 20B shows the device 1230 after a phone keypad 1234 has been extended from a side of the device 1230. The device 1230 in FIG. 20B is in a voice phone mode, and the display 1231 in both FIGS. 20A and 20B is in a portrait mode (with text in a portrait orientation). A full keyboard may be extended from a side of the device 1230 to allow the device to be used in a full keyboard mode. FIG. 20C shows an example of device 1230 being used in a full keyboard mode. A full keyboard 1234A is shown extended from the side of device 1230, and, in this example of FIG. 20C, the full keyboard 1234A includes the phone keypad 1234 so the user can select between voice phone mode or full keyboard mode by extending (e.g. by sliding out) the keyboard partially (to reveal only the phone keypad 1234) or completely (to reveal the entire full keyboard 1234A). In full keyboard mode, the display has text in a landscape orientation. The keyboard 1234A includes two sets of indicia which are substantially perpendicular to each other (e.g. the up/down direction of the “9” on the phone keypad is perpendicular to the up/down direction of the “X” on the full keyboard). It will be appreciated that an alternative embodiment of the device 1230 may have two different keyboards, one for the phone keypad and another for the full keyboard, each of which extend out from one or more sides of the device.

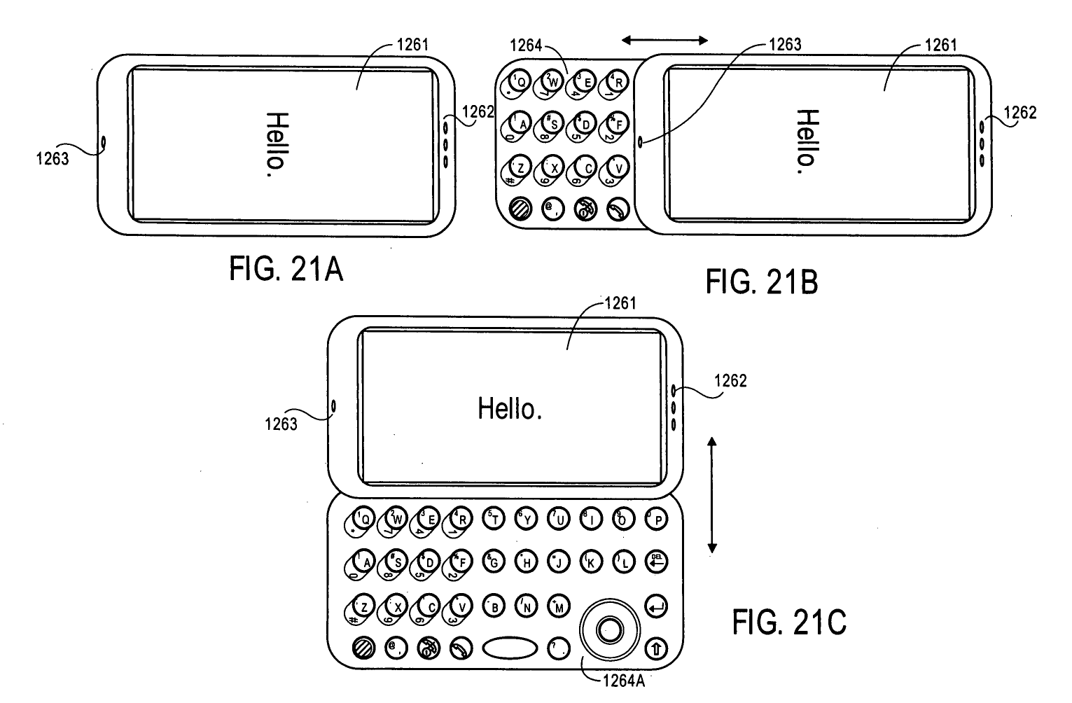

FIGS. 21A, 21B, and 21C show another exemplary embodiment of a portable communication device of the present invention. The device 1260 includes a display 1261 which occupies most of the top surface, shown in the top plan view of FIG. 21A, of the device 1260. This top surface also includes a microphone 1263 and a speaker 1262. FIG. 21A shows the device 1260 in a voice phone mode without any keypad being extended from a side of the device. The device 1260 may be used in the voice phone mode (e.g. to start or receive a phone call, etc.) without the phone keypad being extended if the display 1261 is touch sensitive and displays an activatable phone keypad on the display. FIG. 21B shows the device 1260 after a phone keypad has been extended from a short side of the device 1230. The device 1260 in FIG. 21B is also in a voice phone mode with the display showing text in a portrait orientation. A full keyboard may be extended from a long side of device 1260, as shown in FIG. 21C, to allow the device to be used in a full keyboard mode. The display 1261 in FIG. 21C shows text in a landscape orientation such that a row of text on the display is parallel with a long side of the display. In the example of FIG. 21C, the full keyboard 1264A includes the phone keypad 1264 so the user can select between voice phone mode or full keyboard mode by extending the same keyboard structure either out the short side (as in FIG. 21B) or out the long side (as in FIG. 21C). The keyboard 1264A includes two sets of indicia which are substantially perpendicular to each other. It will be appreciated that an alternative embodiment of the device 1260 may have two different keyboards, one for the phone keypad and another for the full keyboard, each of which may extend out from one or more sides of the device.

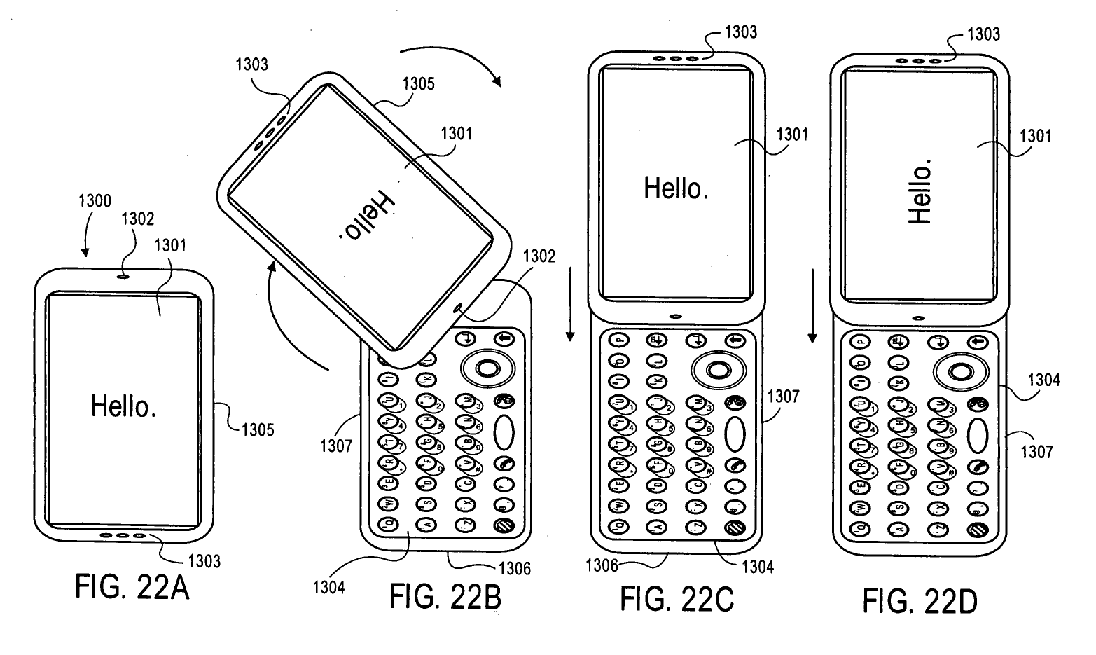

FIGS. 22A, 22B, 22C, and 22D show top plan views of another exemplary embodiment of a portable communication device of the present invention. The device 1300 includes a display assembly 1305 which has a display 1301 and an element 1303 which includes an enabled microphone (in the view of FIG. 22A) and a speaker 1302 (in the view of FIG. 22A). FIG. 22A shows the device 1300 in a voice phone mode without any separate, physical keypad except for a keypad which may be displayed on display 1301 if it has touch sensitive capabilities. The display assembly 1305 is rotatably coupled to an underlying keyboard assembly 1307 which is not visible in FIG. 22A but is visible in FIG. 22B. The display assembly 1305 can be rotated relative to the keyboard assembly 1307, as shown in FIG. 22B, to expose the keyboard assembly. FIG. 22B shows the display assembly 1305 partially rotated between its position shown in FIG. 22A and its position shown in FIG. 22C. In FIG. 22C, the display assembly 1305 has been rotated into a position in which the display assembly 1305 appears to be aligned in a line with the keyboard assembly 1307. The device of FIG. 22C is shown in a voice phone mode, and the text on the display is in a portrait orientation in FIG. 22C, but, as can be seen by comparing FIGS. 22C and 22B, the text has been rotated 180° from the orientation in FIGS. 22A and 22B to the orientation shown in FIG. 22C. The keyboard assembly 1307 includes a keyboard 1304 and a microphone 1306 which is positioned on a front edge of the keyboard assembly 1307. In the configuration shown in FIG. 22C, the element 1303 includes an enabled (for this configuration) speaker while the microphone of element 1303 is disabled, and the speaker 1302 may be disabled. It can be seen from FIG. 22C that the keyboard 1304 includes two sets of indicia arranged substantially perpendicularly to each other; one set of indicia (for the phone keypad) has an up/down direction which is parallel with the up/down direction of text displayed in the voice phone mode (such as the text shown in FIG. 22C), and the other set of indicia (for the full keyboard) has an up/down direction which is parallel with the up/down direction of text displayed in the full keyboard mode (such as the text shown in FIG. 22D). It can be seen from FIGS. 22C and 22D that a row of text in the voice phone mode (in FIG. 22C) is parallel with two sides (in this case the two short sides) of the display 1301 and a row of text in the full keyboard mode (in FIG. 22D) is perpendicular to those two sides. While the example shown in FIGS. 22A-22D show a rectangular display which has two sides longer than two other sides (the “short sides”), alternatives of this embodiment may use a square or nearly square display. In a typical implementation of an embodiment shown in FIGS. 22A-22D, a user may switch between voice phone mode and full keyboard mode (and thereby change the orientation of displayed text) by a keystroke or a selection of a menu command on the display.

The various embodiments described herein have attributes of both a conventional mobile phone, such as a cellular phone, and a data processing system such as a handheld organizer or email processor. It will be appreciated that various different hardware and software implementations may be used to create the various embodiments. FIG. 23 shows one example of an implementation of a portable communication device 1350. The device 1350 includes a display 1380, which may be a liquid crystal display or a light emitting diode (LED) display, and a keyboard 1382, which may be a thumb typing keyboard. The display 1380 is housed in a display assembly such as those shown and described herein, and the keyboard 1382 is housed in a keyboard assembly such as those shown and described herein. The device 1350 further includes a digital baseband and application processor (DBAP) 1352 which is coupled to the display 1380 to provide display data for display (and to receive inputs from the display if it is a touch sensitive display) and which is coupled to the keyboard 1382 to receive inputs (e.g. characters or cursor movements) from the keyboard 1382. The DBAP 1352 processes inputs and prepares display data in a conventional manner and executes a software program (e.g. an operating system) which controls the DBAP 1352. One or more software programs may provide the logic for sending and receiving emails or text messages and for managing a calendar or list of contacts or a “to do” list or a list of phone numbers and other information and for various other tasks, including controlling the operation of a phone in a voice phone mode. The software programs may be stored in memory in the DBAP 1352 and may also be stored in memory 1378 (e.g. flash memory) which is coupled to DBAP 1352. The memory 1378 may also store a user's data (e.g. lists of contacts, phone numbers, email addresses, “to do” items, calendar entries, etc.). The DBAP 1352 also is coupled to a port for expansion modules (e.g. Smart Digital Cards, etc.) and an external interface 1376 (such as a USB interface). The expansion modules can add additional functionality to the system (e.g. by storing software and data on the modules for games or a dictionary or other useful features), and the external interface allows the device to exchange programs and/or data with other systems (e.g. a user can download an email address book from the user's desktop general purpose computer system, such as a Macintosh computer). The DBAP 1352 is also coupled to an Analog Baseband Controller (ABC) 1354 to exchange data and commands between the DBAP 1352 and the ABC 1354. The ABC 1354 processes data from or for cellular phone signals and generates audio sounds for driving the speaker 1366 and codes audio input (e.g. from the microphone 1368) in order to provide conventional mobile phone functions. The ABC 1354 is also coupled to output devices 1364 to control these devices (e.g. the LEDs in the phone keypad which are turned on in the voice phone mode while the LEDs in the rest of the keys are off). A battery 1372 is coupled to all components in the device 1354 in order to provide power; normally the battery is rechargeable and has an input for being recharged. The ABC 1354 is coupled to an RF (Radio Frequency) transceiver 1356 to bidirectionally exchange data through a wireless medium (e.g. through antenna 1360). The RF transceiver 1356 and the Power Amplifier (PA) 1358 and the switch (SW) 1362 and the antenna 1360 may be conventional cellular telephone components. The device 1350 may further include a position sensor which automatically senses the position of the display assembly relative to the keyboard assembly and which, in response to detecting a change from voice phone mode to full keyboard mode, or vice versa, switches the orientation of text on the display in those embodiments which have such switches of orientation. The position sensor may be a set of electrical contacts or a post and a receptor (e.g. post 1135 and socket 1136 in FIG. 15A) which change the state of one or more switches (from open to closed or vice versa) as the user moves the display assembly relative to the keyboard assembly. The device can automatically perform the change in text orientation using known software techniques in response to this change of state. Alternatively, the user may cause the change in text orientation by a manually entered keystroke (or keystrokes) or by selecting a command from a menu on the display.

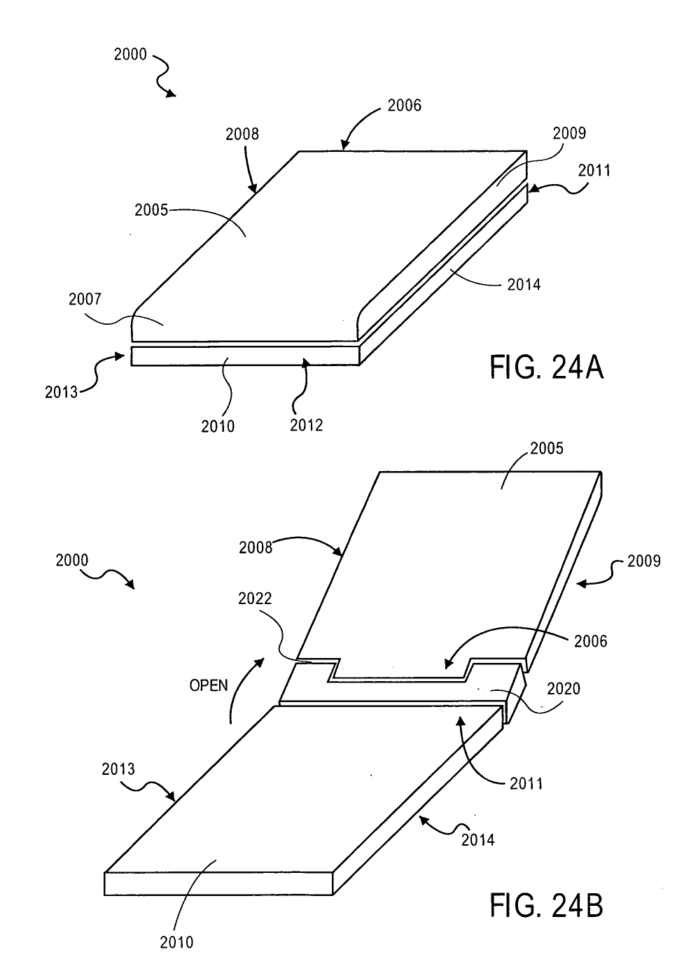

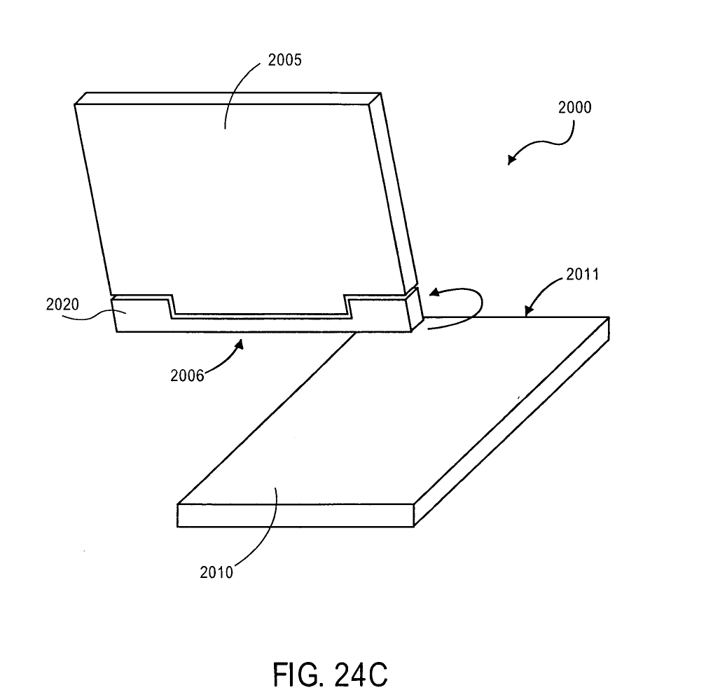

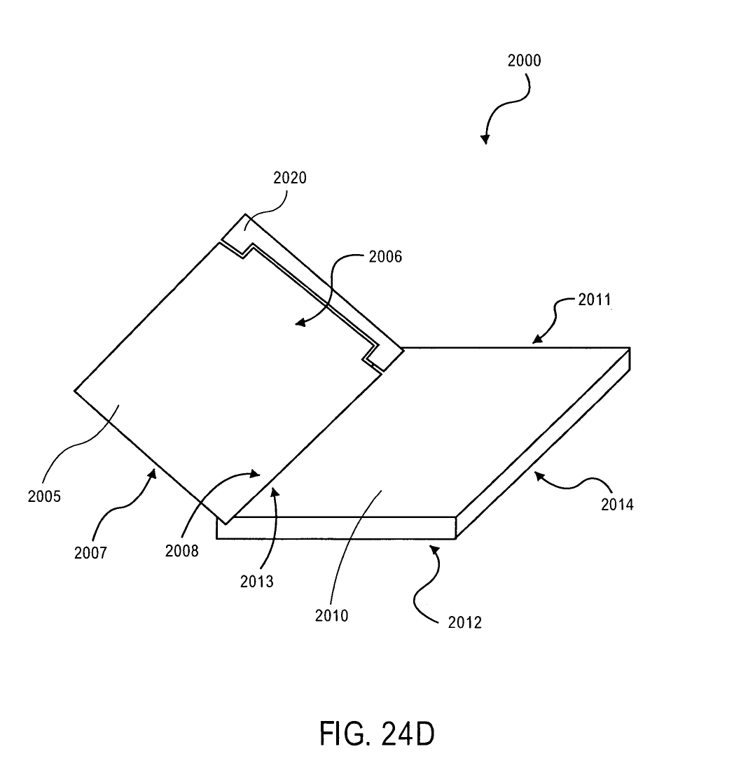

FIGS. 24A-24D illustrate another embodiment of a portable communication device 2000 that may alternate between a first communication configuration and a second communication configuration. The first communication configuration may correspond to a voice phone mode, and the second communication configuration may correspond to a data interactive or personal digital assistant (PDA) mode. It should be noted that portable communication device 2000 illustrated in FIGS. 24A-24D are represented in a simplified form without showing many detailed elements, for the purpose describing with clarity the operation of the hinge assembly. FIG. 24A illustrates portable communication device 2000 in a closed mode or configuration (e.g., device 2000 is placed in a shirt/pant pocket during non-use), in which a display assembly 2005 is closed over input assembly 2010. In one embodiment, display assembly 2005 is similar to the display assemblies described above (e.g., 210, 310, 410), and having many of the features and elements discussed herein, such as a display screen and earpiece. Input assembly 2010 may also be similar to the input assemblies described above (e.g., keyboard assemblies 220, 320), and having many of the features and elements discussed herein, such a full keyboard, numeric keypad, microphone, etc. In the closed configuration, the exterior portions of the display and input assemblies form a protective housing for the portable communication device. In one embodiment, device 2000 may be a smart phone, having for example, voice phone and PDA capabilities, depending on the position of the display assembly 2005 relative to input assembly 2010.

The exterior surfaces of device 2000 includes a display assembly 2005 having a first short side 2006 and a second short side 2007, as well as a first long side 2008 and a second long side 2009. Similarly, input assembly 2010 includes a first short side 2011, a second short side 2012, a first long side 2013, and a second long side 2014. Display assembly 2005 and input assembly 2010 are substantially similar dimensions, allowing for both parts to rest flush with each other in the closed configuration.

FIG. 24B illustrates portable communication device 2000 in a voice phone mode (i.e., the first communication configuration), with display assembly 2005 rotated open relative to input assembly 2010. In this view, hinge assembly 2020, which couples display assembly 2005 to input assembly 2010, is shown. As described in greater detail below, hinge assembly 2020 permits portable communication device 2000 to change into a number of different configurations or communication modes. In one embodiment, display assembly 2010 rotates open from the closed configuration about a first portion 2022 of hinge assembly 2020 to about 90 degrees to about 170 degrees to form the voice phone mode configuration (analogous to the configuration of device 200 illustrated in FIG. 2A). With hinge assembly 2020 disposed between display assembly 2005 and input assembly 2010, first short side 2006 of display assembly 2005 substantially abuts first short side 2011 of input assembly 2010. First long side 2008 of display assembly 2005 is in a plane substantially similar to first long side 2013 of input assembly 2010, and second long side 2009 of display assembly 2005 is in a plane substantially similar to second long side 2014 of input assembly 2010.

FIG. 24C illustrates a transitional or intermediate configuration of portable communication device 2000 as it changes from a voice phone mode of FIG. 24B to a keyboard or data interaction mode (i.e., the second communication configuration) as illustrated in FIG. 24D. The mode associated with the second communication configuration may also be referred to as a PDA or text messaging mode. In order to change from the voice phone mode to the keyboard mode, hinge assembly 2020 swings outward approximately 180 degrees so that first short side 2006 of display assembly 2005 is substantially aligned with first short side 2011 of input assembly 2010. In this position, a backside or exterior housing portion of display assembly 2005 is angled toward input assembly 2010 (i.e., a display or display screen side of display assembly 2005 faces away from input assembly 2010). To form the keyboard configuration of FIG. 24D, display assembly 2005 rotates back toward first long side 2013 of input assembly 2010 so that first long side 2008 of display assembly 2005 substantially abuts or rests adjacent to first long side 2013 of input assembly 2010. First short side 2006 of display assembly 2005 is in a plane substantially similar to first short side 2011 of input assembly 2010, and said second short side 2007 of display assembly 2005 is in a plane substantially similar to second short side 2012 of input assembly 2010.

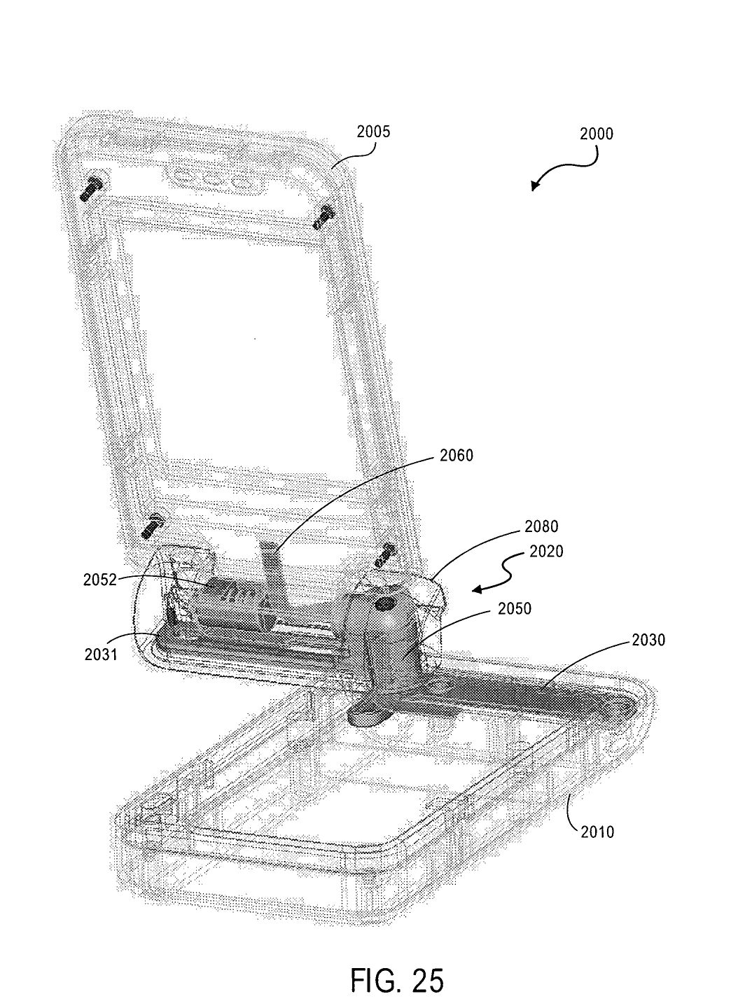

FIG. 25 illustrates a partial see-through view of hinge assembly 2020 in the transitional configuration, as first illustrated for portable communication device 2000 in FIG. 24C. As described in greater detail below, one or more cam assemblies disposed within hinge assembly 2020 allow portable communication device 2000 to rotate and alter between multiple communication modes and/or configurations. Hinge assembly 2020 includes a lower bracket 2030 coupled to input assembly 2010 and an upper bracket 2031 coupled to display assembly 2005. Lower bracket 2030 and upper bracket 2031 may be secured to input assembly 2010 and display assembly 2005, respectively, with one or more screws (not shown). A first cam assembly 2050 is disposed within a slot portion 2052 of lower bracket 2030 and a second cam assembly is disposed along a length of upper bracket 2032. The first cam assembly 2050 allows for the rotation of hinge assembly 2020 (and in effect, display assembly 2005) from the configuration as illustrated in FIG. 24B to the configuration illustrated in FIG. 24C. That is, first cam assembly 2050 allows for the transition from voice phone mode to keyboard mode. The second cam assembly allows for the rotation of display assembly 2005 from the configuration illustrated in FIG. 24A to the configuration illustrated in FIG. 24B, as well as from the configuration in FIG. 24C to the configuration illustrated in FIG. 24D. That is, second cam assembly 2052 allows portable communication device 2000 to change from the closed, protective housing mode to the voice phone mode, as well as from the transition mode to the keyboard mode. It may be appreciated that although first cam assembly 2050 and second cam assembly 2052 are described separately, in one embodiment, both cam assemblies work together seamlessly to allow portable communication device 2000 to change communication configurations.

FIG. 25 also illustrates flex circuit 2060 extending from display assembly 2005 and routed through hinge assembly 2020 into input assembly 2010. In one particular embodiment, a portion of flex circuit 2060 wraps partially around first cam assembly 2050 before extending into input assembly 2010. A portion of flex circuit 2060 serves as a service loop area in which space is formed in the display assembly 2005 for flex circuit 2060 to partially fold or bunch up. For example, portable communication device 2000 may not require flex circuit 2060 to extend its full length while in the voice phone mode, but does require full extension in the keyboard mode. As such, an area in display assembly 2005 is reserved for the extra accumulation of flex circuit 2060 in the voice phone mode. It should be noted that “service loop” does not necessary indicate that flex circuit 2060 form a roll in a particular configuration, but may accumulate in forms of folds or overlapping segments.

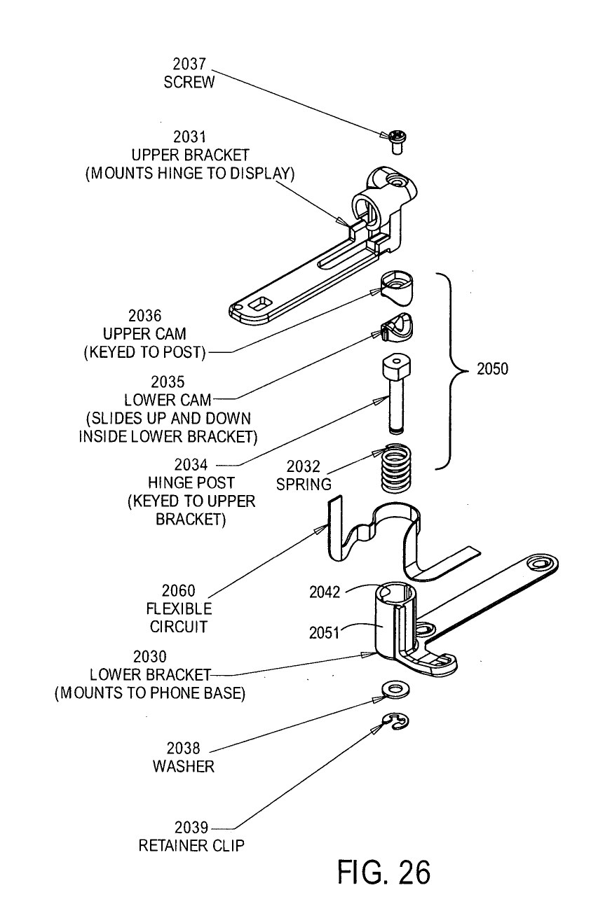

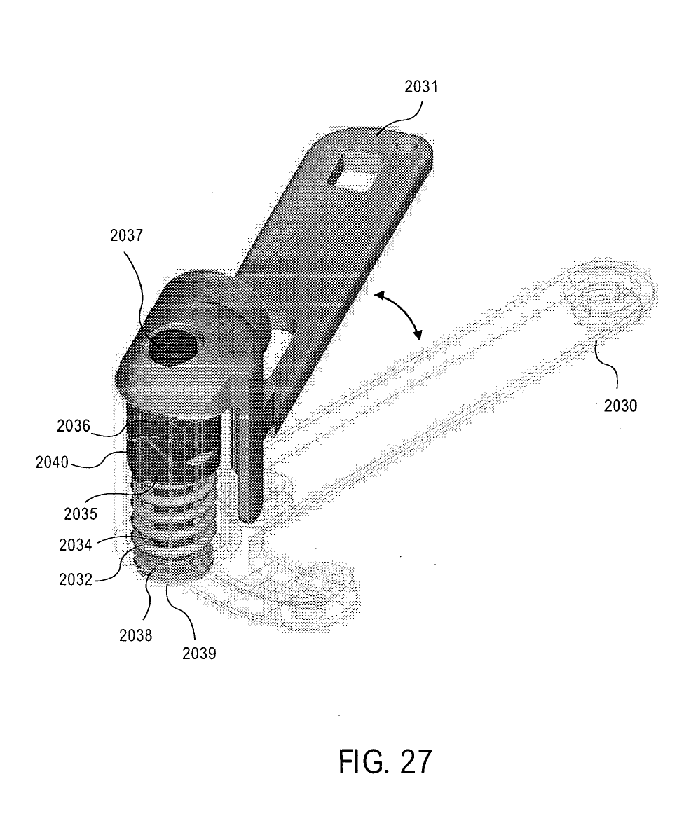

FIG. 26 illustrates an exploded view of hinge assembly 2020 that also includes the components of first cam assembly 2050. For purposes of clarity, components of second cam assembly 2052 are not shown with respect to FIG. 26. A slot or barrel portion 2045 of lower bracket 2030 supports first cam assembly 2050 which includes spring 2032, hinge post 2034, lower cam 2035, and upper cam 2036. Although hinge post 2034 is illustrated as positioned between spring 2032 and lower cam 2035, hinge post may alternatively be disposed above lower cam 2035 and upper cam 2036 in the assembled configuration. In one embodiment of an assembled configuration, hinge post 2034 is keyed with upper bracket 2031, upper cam 2036 is keyed to hinge post 2034. Lower cam 2035 is disposed within lower bracket 2030 and allowed to slide up and down along a protrusion 2040 formed on the exterior surface of lower cam 2035, and a detent 2042 formed along an inner surface of barrel portion 2045 of lower bracket 2030. The up/down sliding or movement of lower cam 2035 corresponds to a turning of upper bracket 2031. Because the upper cam 2036 is keyed to hinge post 2034 (which is coupled to upper bracket 2031), hinge post 2034 also turns in response to a movement of upper bracket 2031. As discussed above, the movement or rotation of upper bracket 2031 corresponds to a communication mode change, in one embodiment, from a voice phone mode to a keyboard mode.

In one embodiment of assembling hinge assembly 2020, hinge post 2034 is keyed into upper bracket 2031, and mounted and secured together with screw 2037. Upper cam 2036 is then placed over and keyed to hinge post 2034. Spring 2032 is then disposed within barrel portion 2051 of lower bracket 2030, and lower cam 2035 is then disposed above spring 2032. The upper bracket/hinge post assembly is then mated with the lower bracket assembly (i.e., slide down into barrel portion 2051 of lower bracket 2030). An end portion of hinge post 2034 is exposed through a bottom of lower bracket 2030 which is coupled with a washer 2038 and retainer clip 2039 (e.g., an e-clip) to hold the entire assembly together. In one embodiment, the feel or tactile response of hinge assembly 2020 may be changed or altered using different types of cam surfaces. Alternatively, hinge assembly 2020 may also be changed by using different types of springs or spring materials (e.g., altering compression strengths of spring 2032).

FIG. 27 illustrates a partially see-through view of first cam assembly 2050 disposed within hinge assembly 2020. Upper bracket 2031 is shown partially rotated with respect to lower bracket 2030 (e.g., rotating towards the transition configuration of FIG. 24C). Hinge post 2034 is keyed to upper bracket 2031 and secured with screw 2037. Hinge post 2034 extends through upper cam 2036, lower cam 2035, and is secured to lower bracket 2030 with washer 2038 and clip 2039. In the rotation position of upper bracket 2031 relative to lower bracket 2030, upper cam 2036 moves with respect to lower cam 2035. Upper cam 2036 and lower cam 2035 have curved or wave-like edges that complement each other when upper bracket 2031 is aligned directly over lower bracket 2031 (e.g., 0 degree position or voice phone mode configuration) and also when upper bracket 2031 extends along a line of lower bracket 2030 (e.g., 180 degree position or the transition/keyboard configuration). The wave-like edges bias the cam into either of the two positions so that the user feels a spring-like force of the hinge assembly from the voice phone mode to the keyboard mode, and vice versa.

In the position illustrated in FIG. 27, upper cam 2036 is rotated slightly so that the curved portions of upper cam 2035 and lower cam 2035 do not complement each other fully. As such, a bias towards the upper bracket 2031 rotating towards lower bracket 2030 exists. A user would have to apply enough force to overcome this bias to rotate upper bracket 2031 away from lower bracket 2030 (e.g., to change into keyboard mode). As described above, as upper cam rotates 2036 rotates relative to lower cam 2035, lower cam moves up or down within lower bracket 2030, in particular, with protrusion 2040 traveling along a detent formed within barrel portion 2051.

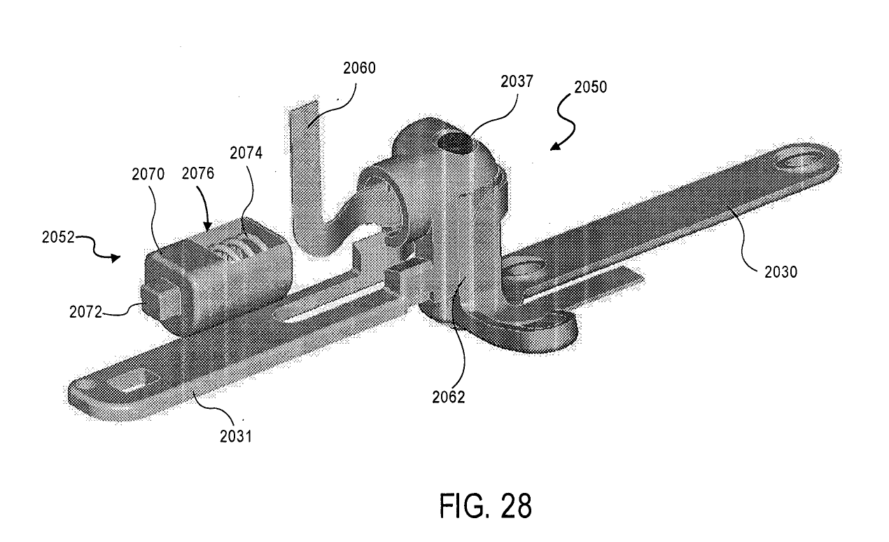

FIG. 28 illustrates another view of hinge assembly 2020 that isolates first cam assembly 2050 and second cam assembly 2052. FIG. 28 may be viewed with respect to FIG. 25 for the description provided herein. Second cam assembly 2052 controls the opening and closing of display assembly 2005 from the closed configuration to the voice phone mode configuration, as well as from the transition configuration to the keyboard configuration. In one embodiment, second cam assembly 2052 allows display assembly 2005 to rotate up to approximately 180 degrees. For example, display assembly 2005 may rotate open to about 160 degrees in the voice phone mode configuration, and then an additional 20 degrees in the keyboard configuration. Second cam assembly 2052 includes a cam housing 2070 that holds a spring 2074 and a cam 2076 therein. Cam housing 2070 is disposed along a length of upper bracket 2031 and is coupled to hinge assembly housing 2080 of hinge assembly 2020 with a protrusion or key portion 2072 that fits into a slot near one end of hinge assembly housing 2080. In one embodiment, second cam assembly 2052 is positioned substantially perpendicular to first cam assembly 2050.

Upper bracket 2031 is shown rotated approximately 180 degrees relative to lower bracket 2030. As described above, this is the position of upper bracket 2031 for portable communication device 2000 in either the transition or keyboard configuration. In the voice phone mode configuration, upper bracket 2031 would be positioned above and substantially aligned with lower bracket 2030. In one embodiment, a ridge 2062 may be formed along an exterior surface of barrel portion 2051. Ridge 2062 serves to prevent upper bracket 2031 from rotating beyond about 180 degrees. Flex circuit 2060 is routed through upper bracket 2031 and around barrel portion 2051 of lower bracket 2030. This particular routing of flex circuit 2060 provides the advantage of using a relatively short flex circuit and still allowing hinge assembly 2020 to move through a wide range of motion. In one embodiment, flex circuit 2060 is a patterned arrangement of printed wiring utilizing a flexible base material with or without flexible cover layers allowing for three-dimensional interconnections of electrical components (e.g., input assembly 2010 components to display assembly 2005 components). Flex circuit 2060 may be any one of those known in the art, and may be selected for high-frequency flexing (e.g., opening display assembly or rotating display assembly more than hundreds of times per day). In an alternative embodiment, a twisted wire bundle formed from micro coax wire may be used in place of flex circuit 2060 (e.g., twisted bundle 1116 described above with respect to FIG. 14).

Hinge assembly 2020 provides several convenient and advantageous features for a user of portable communication device 2000, particularly for that of a “smart phone” which integrates features of a voice phone communication device (e.g., a cellular mobile phone) with a non-voice communication device (e.g., PDA, text-messaging communicator, or web surfing device). In one embodiment, portable communication device 2000 is very robust, having minimal moving parts and a hinge assembly 2020 securely coupling display assembly 2005 and input assembly 2010. The length of flex circuit 2060 is minimized because of the particular routing from display assembly 2005 to input assembly 2010, as described above with respect to FIGS. 25-28. As such, less cabling is required while still allowing hinge assembly 2020 to move in wide range of motion in order to change from the voice phone configuration to the keyboard configuration. Flex circuit 2060 includes a portion that serves as a service loop in one configuration (e.g., the closed configuration) and extends in length as hinge assembly 2020 rotates away from input assembly 2010 to change into the keyboard configuration.

Another advantageous feature the portable communication device 2000 provides is the ability to interchange from the voice phone configuration to the keyboard configuration without portable communication device 2000 having to close first. For a user, this would be particularly inconvenient if while using device 2000 in the voice phone mode, he or she had to retrieve or input data in the keyboard mode. Prior art devices require that the user close and reopen the device in the PDA configuration for activation, essentially making the user disconnect the voice communication. Portable communication device 2000, on the other hand, can easily interchange between configuration modes without closing (as described above with respect to FIGS. 24A-24D). Lastly, device 2000 is relatively small for having smart phone features, due in part to the design of hinge assembly 2020, allowing display assembly 2005 to rotate easily with respect to input assembly 2010.

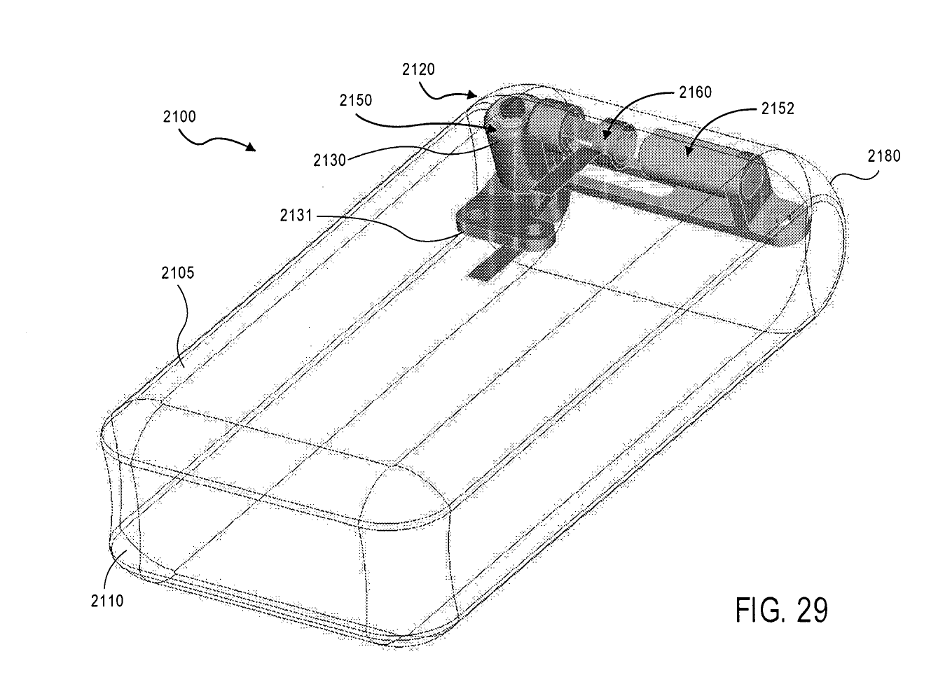

FIG. 29 illustrates another portable communication device 2100 having an alternative hinge assembly 2120. Portable communication device 2100 is shown in the closed position with display assembly 2105 folded over input assembly 2110 with certain components of hinge assembly 2120 shown in a partial see-through view. A hinge frame 2130, which is coupled to display assembly 2105, is disposed within hinge assembly housing 2180. A mounting bracket 2131 couples hinge assembly 2120 to input assembly 2110. Hinge assembly 2120 includes similar structural elements as hinge assembly 2020 described above but differs, in one aspect, in the manner in which flex circuit 2160 is routed from display assembly 2105 to input assembly 2110. A portion of flex circuit 2160 extending from display assembly 2110 forms a coil within hinge assembly housing 2180 before extending towards and wrapping around a portion of hinge frame 2130 and coupling with input assembly 2110.

As described in greater detail below, the coiled portion of flex circuit 2160 produces a torsion spring-like effect to aid in the rotation of hinge assembly 2120. A first cam assembly 2150 is disposed within hinge frame 2130 and a second cam assembly 2152 is disposed near an opposite end of hinge frame 2130. Analogous to first cam assembly 2050 and second cam assembly of 2052 of portable communication device 2000, first cam assembly 2150 and second cam assembly 2152 allows portable communication device 2100 to change from the closed configuration of FIG. 29 to a voice phone mode configuration and a keyboard configuration.

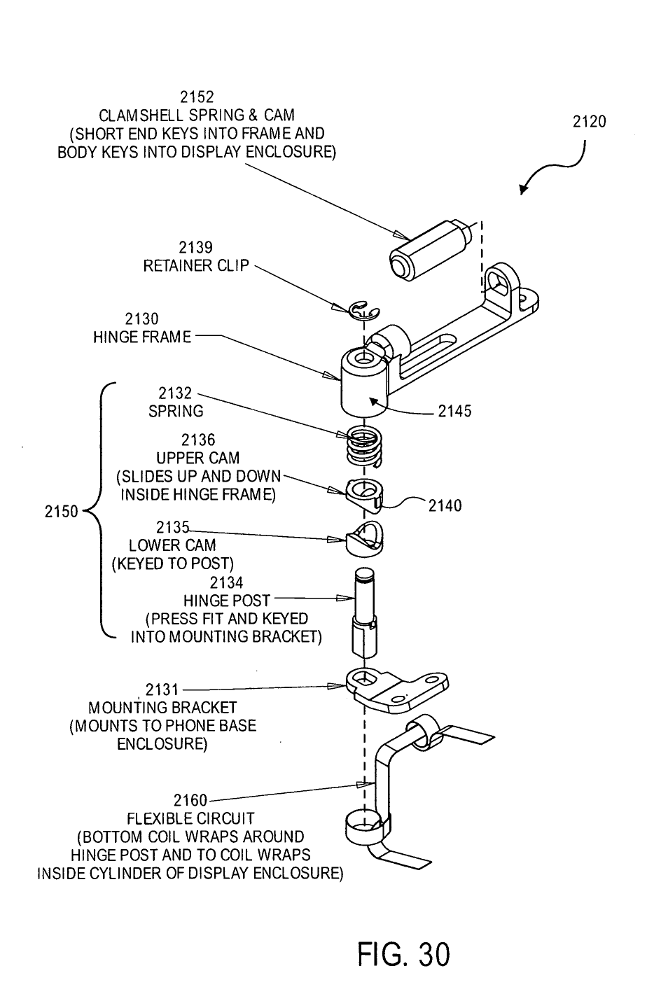

FIG. 30 illustrates an exploded view of the internal components of hinge assembly 2120 to show, in one embodiment, the assembly of first cam assembly 2150 and second cam assembly 2152 to hinge frame 2130. Second cam assembly 2152, which includes a clamshell spring and a cam disposed internally (not shown) is keyed on one end to hinge frame 2130 and keyed to display assembly 2105 on the opposite end. A slot or barrel portion 2140 of hinge frame 2130 supports first cam assembly 2150 which includes spring 2132, hinge post 2134, lower cam 2135, and upper cam 2136. In one embodiment of an assembled configuration, hinge post 2134 is keyed with hinge frame 2130, upper cam 2136 is keyed to hinge post 2134, and lower cam 2135 is disposed within hinge frame 2130 and allowed to slide up and down along a protrusion 2140 formed on the exterior surface of lower cam 2135 and a detent (not shown) formed along an inner surface of barrel portion 2145 of hinge post 2134. The up/down sliding or movement of lower cam 2135 corresponds to a rotational movement of upper bracket 2031. Because upper cam 2136 is keyed to hinge post 2134 (which is coupled to hinge frame 2130), hinge post 2134 also turns in response to a movement of hinge frame 2130. An opposite end of hinge post 2134 extends through mounting bracket 2131, which is coupled to the input assembly. As discussed above, the movement or rotation of hinge frame 2130 corresponds to a communication mode change, in one embodiment, from a voice phone mode to a keyboard mode.

In one embodiment of assembling hinge assembly 2120, upper cam 2136 is placed over and keyed to hinge post 2134. Spring 2132 is then disposed within barrel portion 2145 of hinge frame 2130, and lower cam 2135 is then disposed above spring 2132. An end portion of hinge post 2134 is exposed through barrel portion 2145 of hinge frame 2130 which couples with retainer clip 2139 (e.g., an e-clip) that holds the entire assembly together. An opposite end of hinge post 2134 extends through mounting bracket 2131. Mounting bracket 2131 is coupled to the input assembly, and in one embodiment, may be secured with one or more screws. In one embodiment, the feel or tactile response of hinge assembly 2120 may be changed or altered using different types of cam surfaces. Alternatively, hinge assembly 2120 may also be changed by using different types of springs or spring materials (e.g., altering compression strength) for spring 2132. Flex circuit 2160, which extends from display assembly 2105, is routed through hinge frame 2130, with a portion of flex circuit 2160 wrapped around barrel portion 2145 of hinge frame 2130 near input assembly 2110, and a portion that coils within hinge assembly housing 2180 as described above with respect to FIG. 29.

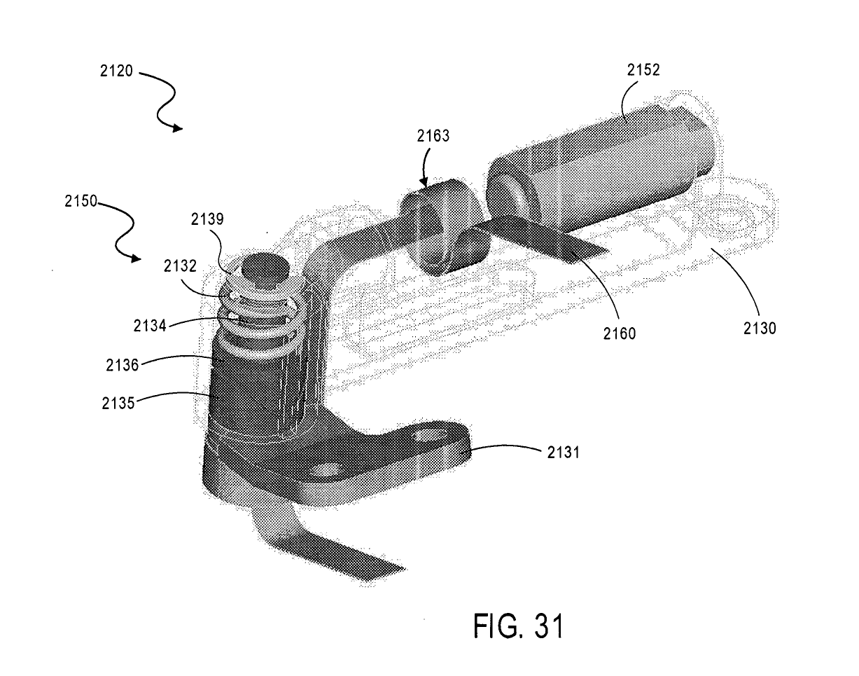

FIG. 31 is a partial see-through view of hinge assembly 2120 illustrating an enlarged view of first cam assembly 2150, second cam assembly 2152, and flex circuit 2160. With respect to the display assembly 2105 and input assembly 2110 (not shown), hinge assembly 2120 is in a position for portable communication device to be in a closed configuration (i.e., display assembly 2105 closed over input assembly 2110 as illustrated in FIG. 29). Flex circuit 2160 extends from the display assembly, forms a loop or coil 2163, and extends along hinge frame 2130 toward first cam assembly 2150. A portion of flex circuit 2160 wraps around barrel portion 2145 of hinge frame 2130 before extending towards the input assembly.

In one embodiment, coil 2163 operates as a service loop or jog for flex circuit 2160 as portable communication device 2100 changes from voice phone mode to keyboard mode. For example, in the closed configuration, flex circuit 2160 is in a relaxed state with some jog, with a relatively loose loop (i.e., coil 2163), and with one end fixed to the input assembly. As hinge assembly 2120 rotates, coil 2163 tightens, as a certain amount of flex circuit travel is necessary to allow hinge assembly 2120 to rotate fully (e.g., approximately 180 degrees). In an alternative embodiment, a twisted wire bundle formed from micro coax wire may be used in place of flex circuit 2160 (e.g., twisted bundle 1116 described above with respect to FIG. 14).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A portable communication device, comprising:
a display assembly having a first bracket rotatably coupled to a keyboard assembly having a second bracket;
a first cam assembly and a second cam assembly disposed between said first bracket and said second bracket; and
a flex circuit to extend from said display assembly to said input assembly, wherein a portion of said flex circuit is wrapped around said first cam assembly, and wherein said display assembly rotates about said first cam assembly to form a full keyboard configuration and rotates about said second cam assembly to form a voice phone configuration.

2. The portable communication device of claim 1, wherein said first cam assembly includes a post keyed to said upper bracket, an first cam keyed to said post, a first spring disposed around said post, and a second cam that slides within said lower bracket to correspond to a rotation of said upper bracket relative to said lower bracket.

3. The portable communication device of claim 2, wherein said second cam comprises a third cam and a spring disposed within a cam housing, wherein said second cam assembly is positioned perpendicular to said first cam assembly.

4. The portable communication device of claim 3, wherein said second cam assembly allows said display assembly to rotate open relative to said keyboard assembly to an angle between about 90 degrees to about 170 degrees in said voice phone configuration.

5. The portable communication device of claim 4, wherein said first cam assembly allows said display assembly to rotate away from keyboard assembly, and wherein a display side of said display assembly initially faces away from said keyboard assembly before rotating back towards said keyboard assembly to form said full keyboard configuration.

6. The portable communication device of claim 5, wherein a portion of said flex circuit comprises a service loop having a length that expands in said full keyboard configuration and contracts in said voice phone configuration.

7. The portable communication device of claim 6, wherein said service loop is a coil disposed near said display assembly.

8. The portable communication device of claim 7, wherein said full keyboard configuration corresponds to a PDA mode.

9. A portable communication device, comprising:
a display assembly rotatable with respect to an input assembly to alternate between a first communication configuration and a second communication configuration;
a hinge having a cam assembly to rotate said display assembly relative to said input assembly; and
a flex circuit extending from said display assembly to said input assembly and coupled to said cam assembly, wherein said flex circuit is routed around a portion of said cam assembly and also includes a service loop to expand and contract between said first communication configuration and said second communication configuration.

10. The portable communication device of claim 9, wherein said cam assembly further comprises:
an upper bracket coupled to said display assembly and a lower bracket coupled to said input assembly, said lower bracket having a slot portion;
a hinge post keyed to said upper bracket;
an upper cam keyed to said hinge post; and
a lower cam disposed within said slot portion of said lower bracket, wherein a turning of said upper bracket relative to said lower bracket corresponds to an up and down movement of said lower cam and rotation of said display assembly relative to said input assembly.

11. The portable communication device of claim 10, wherein said flex circuit extends through a portion of said upper bracket and around said lower bracket.

12. The portable communication device of claim 10, wherein said first communication configuration corresponds to a voice phone mode, and wherein said wherein said service loop includes a portion of said flex circuit that accumulates near said display assembly.

13. The portable communication device of claim 12, wherein said second communication configuration corresponds to a keyboard mode, and wherein said service loop extends near said display assembly.

14. The portable communication device of claim 13, wherein said display assembly and said input assembly each has a first and a second long side and a first and a second short side, and wherein in said voice phone mode, said first long side of said display assembly is in a plane substantially similar to said first long side of said input assembly, and said second long side of said display assembly is in a plane substantially similar to said second long side of said input assembly.

15. The portable communication device of claim 14, wherein in said keyboard mode, said first short side of said display assembly is in a plane substantially similar to said first short side of said input assembly, and said second short side of said display assembly is in a plane substantially similar to second short side of said input assembly.

16. The portable communication device of claim 10, wherein said service loop includes a coil that contracts in said first communication configuration and expands in said second communication configuration.

17. A portable communication device, comprising:
a display assembly rotatable with respect to an input assembly to alternate between a first communication configuration and a second communication configuration, said display assembly and said input assembly each having a first and a second short side and a first and a second long side; and
a hinge assembly to couple said display assembly to said input assembly, said hinge assembly comprising:
a lower bracket coupled to said input assembly;
an upper bracket coupled to said display assembly; and
a first cam assembly and a second cam assembly disposed between said lower bracket and said upper bracket, wherein said first cam assembly rotates said upper bracket away from said lower bracket toward said second communication configuration, and said second cam assembly rotates said display assembly open relative to said input assembly toward said first communication configuration.

18. The portable communication device of claim 17, wherein said first communication configuration corresponds to a voice phone mode in which said first long side of said display assembly is in a plane substantially similar to said first long side of said input assembly, and said second long side of said display assembly is in a plane substantially similar to second long side of said input assembly.

19. The portable communication device of claim 17, wherein said second communication configuration corresponds to a keyboard mode in which said first short side of said display assembly is in a plane substantially similar to said first short side of said input assembly, and said second short side of said display assembly is in a plane substantially similar to second short side of said input assembly.

20. The portable communication device of claim 17, wherein said input assembly comprises a keyboard having alphanumeric keys for operation in both first and second communication configurations.

21. The portable communication device of claim 17, further comprising a flex circuit routed from said display assembly to said input assembly, wherein said flex circuit is partially wrapped around said first cam assembly.

22. The portable communication device of claim 17, wherein a length of said flex circuit includes a service loop portion that expands in said second communication configuration and contracts in said first communication configuration.

23. A portable communication device, comprising a hinge assembly to alternate a display assembly with respect to an input assembly between a first communication configuration and a second communication configuration, said display assembly and said input assembly each having a first and a second short side and a first and a second long side, said first communication configuration formed by said first short side of said display assembly substantially abutting said first side of said input assembly, said second communication configuration formed by said first long side substantially abutting said first long side of said input assembly, said portable communication device also having a transitional configuration between said first communication configuration and said second communication configuration wherein said first short side of said display assembly is rotated away and substantially aligned with said first short side of said input assembly.

24. The portable communication device of claim 23, wherein said first communication configuration corresponds to a voice phone mode and said second communication configuration corresponds to a personal digital assistant mode.

25. The portable communication device of claim 24, further comprising a flex circuit that extends from said display assembly to said input assembly, said flex circuit including a service loop portion.

26. The portable communication device of claim 25, wherein said first communication configuration corresponds to a voice phone mode and said second communication configuration corresponds to a PDA mode.

27. The portable communication device of claim 26, wherein said service loop of flex circuit expands in said PDA mode and contracts in said voice phone mode.
